(19) United States
(12) Patent Application Publication
(10) Pub. No.: US 2018/0232702 A1
(43) Pub. Date: Aug. 16, 2018

(54) USING FEEDBACK TO RE-WEIGHT CANDIDATE FEATURES IN A STREAMING ENVIRONMENT

(71) Applicant: Microsoft Technology Licensing, LLC, Redmond, WA (US)

(72) Inventors: Vijay Dialani, Fremont, CA (US); Sahin Cem Geyik, Redwood City, CA (US); Xianren Wu, San Jose, CA (US); Abhishek Gupta, San Francisco, CA (US)

(21) Appl. No.: 15/851,584

(22) Filed: Dec. 21, 2017

Related U.S. Application Data
(60) Provisional application No. 62/459,703, filed on Feb. 16, 2017.

(51) Int. Cl. G06Q 10/10; G06F 17/30; G06Q 50/00

(52) U.S. Cl. CPC G06Q 10/1053; G06Q 50/01; G06F 17/30011; G06F 17/30867

(57) ABSTRACT

Techniques for dynamically altering weights to re-weight candidate features of a candidate search and ranking model in a streaming environment are described. In an embodiment, a disclosed system obtains desired hire documents using a search query specifying parameters. Additionally, the system extracts desired hire-based features from the documents, with the features corresponding to the parameters. Moreover, the system inputs the features to a combined ranking model that is trained by a machine learning algorithm to output a ranking score for each of the documents, with the combined ranking model including weights assigned to each of the features. Furthermore, the system ranks the desired hire documents based on the ranking scores and displays top ranked documents. Then, feedback is received regarding the top ranked documents, and the weights assigned to each of the features are dynamically trained to alter the weights assigned to each of the features based on the feedback.

### PRIORITY CLAIM

This application claims the benefit of priority to U.S. Provisional Patent Application No. 62/459,703 entitled “Using Feedback to Re-weight Candidate Features in a Streaming Environment”, [reference number 901989-US-PSP (3080H83PRV)] filed Feb. 16, 2017, which is incorporated herein by reference in its entirety.

### TECHNICAL FIELD

The present disclosure generally relates to computer technology for solving technical challenges in search queries to data sources. More specifically, the present disclosure relates to the dynamic alteration of weights to re-weight candidate features of a candidate search and ranking model in a streaming environment.

### BACKGROUND

The rise of the Internet has occasioned two disparate phenomena: the increase in the presence of social networks, with their corresponding member profiles visible to large numbers of people, and the increase in use of social networks for job searches, both by applicants and by employers. Employers, or at least recruiters attempting to connect applicants and employers, often perform searches on social networks to identify candidates who have qualifications that make them good candidates for whatever job opening they are attempting to fill. The employers or recruiters then can contact these candidates to see if they are interested in applying for the job opening.

Traditional querying of social networks for candidates involves the employer or recruiter entering one or more search terms to manually create the query. A key challenge in talent search is to translate the criteria of a hiring position into a search query that leads to desired candidates. To fulfill this goal, the searcher has to understand which skills are typically required for the position, what the alternatives are, which organizations are likely to have such candidates, which schools the candidates are most likely to graduate from, and so forth. Moreover, the knowledge varies over time. As a result, it is not surprising that even for experienced recruiters it often requires many searching trials in order to obtain a satisfactory query.

### BRIEF DESCRIPTION OF THE DRAWINGS

Some embodiments of the technology are illustrated, by way of example and not limitation, in the figures of the accompanying drawings.

FIG. 1 is a block diagram illustrating a client-server system, in accordance with an example embodiment.

FIG. 2 is a block diagram showing the functional components of a social networking service, including a data processing block referred to herein as a search engine, for use in generating and providing search results for a search query, consistent with some embodiments of the present disclosure.

FIG. 3 is a block diagram illustrating an application server block of FIG. 2 in more detail, in accordance with an example embodiment.

FIG. 4 depicts overlaid candidate feature re-ranking results for parameters re-weighted based on feedback received in a streaming environment, in accordance with example embodiments.

FIGS. 5 and 6 depict overlaid candidate feature re-ranking results for parameters, with graphs comparing re-ranking utilizing candidate skill features to re-ranking without utilizing skill features, in accordance with example embodiments.

FIGS. 7 and 8 depict overlaid candidate feature re-ranking results for parameters, with graphs comparing re-ranking utilizing candidate education to re-ranking without utilizing education, in accordance with example embodiments.

FIGS. 9 and 10 depict overlaid candidate feature re-ranking results for parameters, with graphs comparing re-ranking utilizing candidate seniority to re-ranking without utilizing seniority, in accordance with example embodiments.

FIG. 11 depicts normalized discounted cumulative gain (NDCG) improvement for a set of candidates as compared to a baseline, in accordance with an example embodiment.

FIG. 12 is a table listing success bucket definitions, in accordance with an example embodiment.

FIG. 13 is a block diagram illustrating a skills generator in more detail, in accordance with an example embodiment.

FIG. 14 is a diagram illustrating an offline process to estimate expertise scores, in accordance with another example embodiment.

FIG. 15 is a block diagram illustrating a search results ranker in more detail, in accordance with an example embodiment.

FIG. 16 is a block diagram illustrating a search results ranker in more detail, in accordance with another example embodiment.

FIG. 17 is a flow diagram illustrating a method for performing a desired hire-based search, in accordance with an example embodiment.

FIG. 18 is a flow diagram illustrating generating a search query based on one or more extracted features, in accordance with an example embodiment.

FIG. 19 is a flow diagram illustrating a method of ranking search results using desired hires, in accordance with an example embodiment.

FIG. 20 is a flow diagram illustrating a method for generating labels for sample desired hire member profiles, in accordance with an example embodiment.

FIG. 21 is a flow diagram illustrating a method of dynamically training weights of a machine learning algorithm model, in accordance with an example embodiment.

FIG. 22 is a screen capture illustrating a first screen of a user interface for performing a desired hire-based search, in accordance with an example embodiment.

FIG. 23 is a screen capture illustrating a second screen of the user interface for performing a desired hire-based search, in accordance with an example embodiment.

FIG. 24 is a block diagram illustrating a representative software architecture, which may be used in conjunction with various hardware architectures herein described.

FIG. 25 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

The present disclosure describes, among other things, methods, systems, and computer program products that individually provide various functionality. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

In an example embodiment, a system is provided whereby candidate features are re-weighed based on a mixture of explicit and implicit feedback. The feedback can include user feedback for candidates in a given stream. The user can be, for example, a recruiter or hiring manager reviewing candidates in a stream of candidates presented to the user. Explicit feedback can include acceptance, deferral, or rejection of a presented candidate by a user (e.g., recruiter feedback). Explicit feedback can also include a user's Interest in member attributes (i.e., urns) and is used to identify ranking and recall limitations of previously displayed profiles and to devise reformulation schemes for query intent clusters. For example, starting with a set of desired candidates for a title (i.e., desired hires for a given job title) specified by the stream, an embodiment represents a candidate profile as a bag of urns. In this example, an urn is an entity type associated with a member profile, where an entity type represents an attribute or feature of the member's profile (e.g., skills, education, experience, current and past organizations). For instance, member profiles can be uniquely identified by urns, where the urns can include urns for skills (e.g., C++ programming experience) and other urns for company or organization names (e.g., names of current and former employers). Implicit feedback can include measured metrics such as dwell time, profile sections viewed, and number of revisits to a saved candidate profile. Correlations between explicit and implicit feedback are used to determine relative weights of member urns in a profile in order to quickly converge on a set of candidates in a streaming environment.

In certain embodiments, a candidate stream collects two types of explicit feedback. The first type of explicit feedback includes signals from a user such as acceptance, deferral, or rejection of a candidate shown or presented to the user (e.g., a recruiter). The second type of explicit feedback includes member urns that are similar to urns of a desired hire. If the explicit feedback includes many negative responses, an embodiment can prompt the user to ask the user if he wants to see candidates from known connections instead of or in addition to candidates from a stream. In another example, if a user is searching for a game developer with certain experience or skills (e.g., real-time software development skills), the system can use explicit feedback to present known connections who have these skills after a baseline number of candidates that have been accepted.

Explicit feedback can be used to re-weight arms of a multi-armed bandit (MAB) solution, where the MAB solution is used to explore the appropriateness of each of a set of possible user query intents in terms of each intent's match to a current hidden intent of the user. For instance, each arm of the MAB solution can represent an intent, and the choice of weights for these arms can be determined based on user feedback (e.g., recruiter feedback). In some embodiments, explicit feedback is used to populate arms for an MAB approach. According to these embodiments, the MAB approach is away to explore whether, for a current candidate search, certain candidate feature weights are more appropriate for the search.

In some embodiments, implicit feedback can include one or more user feedback signals or measurements such as, for example, the user's dwell time on a presented candidate, a number of a member's profile sections viewed by the user, and a number of revisits by the user to a saved member profile. For instance, implicit feedback can use log data from a recruiting tool to measure an amount of things or items in a member profile a user has reviewed or seen (e.g., a number of profile sections viewed). In this example, such log data from a recruiting product can be used to determine if a user is interested in a particular skill set, seniority or tenure in a position, seniority or tenure at an organization, and other implicit feedback that can be determined from log data. In another example, log data from an automated sourcing or intelligent matches product may be used to determine if a user of the product is interested in a particular skill set, seniority or tenure in a position, seniority or tenure at an organization, and other implicit feedback that can be determined from automated sourcing or intelligent matches log data.

Embodiments incorporate the above-noted types of explicit and implicit feedback signals into a single weighted scheme of signals. This single weighted scheme of signals is used as a correlation between the explicit and implicit feedback to develop attribution schemes for determining relative weights of urns on a member profile. In additional or alternative embodiments, the explicit member urns feedback is used to identify ranking and recall limitations of previously displayed member profiles and to devise reformulation schemes for query intent clusters. The query intent clusters do not require displaying a query for editing by the user. Instead, the user's query can be tuned automatically behind the scenes. For instance, query intent clusters can be used to automatically reformulate and tune a query based on a mixture of explicit and implicit feedback as the user is looking for candidates, and reviews, selects, defers, or rejects candidates in a candidate stream. As used herein, the terms ‘stream of candidates’ and ‘candidate stream’ generally refer to sets of candidates that can be presented or displayed to a user. The user can be a user of a recruiting tool. For example, the user can be a recruiter or a hiring manager that interacts with a recruiting tool to view and review a stream of candidates being considered for a position or job.

The above-noted types of explicit and implicit feedback can be used to promote and demote candidates by re-weighting candidate features. That is, values assigned to weights corresponding to candidate features (e.g., desired hire features) can be re-calculated or re-weighted. Some feedback can conflict with other feedback. For example, seniority feedback can indicate that a user wants a candidate with long seniority at a start-up company, but relatively shorter seniority at a larger organization (e.g., a Fortune 500 company). Embodiments provide valuation or ranking of candidates in a stream of candidates. For example, embodiments can present members with member urns that are similar to a desired hire, but only after the user has rejected a threshold number of candidates in a stream.

In an example embodiment, a system is provided whereby, given a set of input ‘desired’ candidates, a search query is built capturing the key information in the candidates' profiles. The query is then used to retrieve and rank results. In this manner, a searcher may list one or several examples of good candidates for a given position. For instance, hiring managers or recruiters can utilize profiles of existing members of the team for which the position pertains. In this new paradigm, instead of specifying a complex query capturing the position requirements, the searcher can simply pick up a small set of desired hires for the position. The system then builds a query automatically extracted from the input candidates and searches for result candidates based on this built query. In some example embodiments, the automatically constructed query can also be presented to the searcher, which helps explain why a certain result shows up in a search ranking, thereby making the system more transparent to the searcher. Further, the searcher can then interact with the system and have control over the results by modifying the initial query.

Example embodiments provide systems and methods for query intent clustering for a search query, where the search query is a candidate query in a recruiting context. According to these embodiments, an automated sourcing application or an intelligent matches application allows a user, such as, for example, a recruiter or hiring manager, to create a stream from a minimal set of features. As used herein, in certain embodiments, the terms ‘automated sourcing’, ‘intelligent matches’ and ‘intelligent matching’ refer to systems and methods that offer intelligent candidate suggestions to users such as, for example, recruiters, hiring managers, and small business owners. Automated sourcing enables such users to review and select relevant candidates from a candidate stream without having to navigate or review a large list of candidates. For example, automated sourcing can provide a user with intelligent suggestions automatically selected from a candidate stream or flow of candidates for a position to be filled without requiring the user to manually move through a list of thousands of candidates. In the automated sourcing context, such a candidate stream can be created based on minimal initial contributions or inputs from users such as small business owners and hiring managers.

Instead of requiring large amounts of explicit user feedback, automated sourcing techniques infer criteria with features and information derived from the user's company or organization, job descriptions, other companies or organizations in similar industries, and implicit user feedback (e.g., feedback inferred based on recent hires). Among many features or factors that can contribute to the criteria for including members of a social networking service in a stream of candidates, embodiments use a standardized job title and location to start a stream. In certain embodiments, the social networking service is an online professional network. As a user is fed a stream of candidates, the user can assess respective ones of the candidates. This interaction information can be fed back into a relevance engine that includes logic for determining which candidates end up in a stream. In this way, automated sourcing techniques continue to improve the stream.

In certain embodiments, a user of a recanting tool can create a new stream from a standardized title and location combination. In the event that the user does have a company that is standardized, and the tool has enough data on the organization or company to make it useful, an embodiment can also implicitly leverage the organization's or company's industry and other metadata to improve the immediate quality of the stream. For each new stream, a standardized title and location are used to frame the position. The search service can use the recruiting tool's suggested titles and locations to automatically broaden the search. That is, the title and location used to frame the stream are the job title the candidate will have and the location where they will work, as opposed to requiring the user to enter current titles.

An embodiment standardizes company, organization, title, and location values. For example, if the user's standardized company contains enough information to start a stream, an embodiment can personalize the stream based on the company name. This results in immediately improving the relevance model versus needing to wait for additional indicators or parameters. The standardized company can be derived from a user's contract settings or from the user's profile. In certain embodiments, additional questions are incorporated after the initial stream creation to better frame the candidate stream. The amount of these questions are kept as low impact as possible in order to simplify the process of getting started with sourcing candidates. For example, if a user's organization seeks to hire an accountant, an additional question may prompt the user to determine if it is a requirement that candidates have a certified public accountant (CPA) credential. In addition to information that the automated sourcing tool infers, there are interstitial questions that might be asked to help target the stream even further. For example, the tool may prompt the user to determine how senior of a candidate the user is looking for and when the candidate needs to be available to start. These questions can be asked throughout the candidate ranking process and can vary based on the demands of relevancy. Like the initial questions that can be asked, these additional questions are based on how much success the rating flow is having at returning quality, desired candidates. In the streaming environment, that success is measured by the amount of positive ratings for candidates in the stream.

Following the creation of the stream, the user can be dropped into a sourcing flow where they will start to receive candidates one at a time. Action (e.g., feedback) may be required on a candidate to move on to the next one. The current candidate for each stream is tracked, allowing the user to return to where they left off at any point.

A user can use a recruiting tool to move or navigate through a candidate stream. For example, as a stream engine returns each candidate to the user, the user can provide feedback to rate the candidate in one of a discrete number of ways. Non-limiting examples of the feedback include acceptance (e.g., Yes—interested in candidate, deferral (e.g., maybe later) and rejection (e.g., No—not interested).

A candidate stream can be resumed or started from a home screen of the automated sourcing recruiting tool, where a review endpoint is hit. This endpoint returns the next prospect identifier (ID) associated with that specific stream. If it is a suggested stream or new stream, a create call is made first. If it is a current stream that is being resumed, then it goes directly to the review endpoint. With each user rating (e.g., explicit feedback), the following actions can be taken: 1. The stream engine receives the candidate, the project and the rating. This allows updating of a tagging table that is used to track the candidate's rating within a specific recruiting project. At this point, a call can be made (e.g., an application programming interface/API call) to a relevance backend to pass along the rating information. Next, 2for web to API purposes, a posting call will return a success response and the same review endpoint from before will be hit. The review endpoint returns a fully decorated profile for the next stream. An API can handle all profile decoration via a rest call to an identity super block. The candidates are stored in the recruiting project for several reasons, with the main one being that it provides a record of yes/no/deferred feedback to the relevancy engine. The stream may expose previously rated candidates back to user if the training data flags a candidate as a potential rematch (may have been hastily rated, had their profile data updated, has since become a more appropriate candidate, etc.). Another important reason is to allow the user to upgrade to a full recruiter contract at any given time and have all their candidates stored in projects correlated to each stream.

In addition to having the ability to go from an automated sourcing contract to full recruiter contract, an embodiment allows existing recruiters to add automated sourcing as a feature to their account. This means supporting the ability to create automated sourcing streams off of their existing recruiting or staffing projects. Since these projects can be closely tied to each other, some inferences about the candidates that already exist in that recruiter's projects can be made. For example, if the recruiter has a project with 25 candidates that have been contacted, an embodiment can assume the candidates would be tagged with the same ‘automated_good’ ranking just as if they went through automated sourcing. This allows for an easy mapping when it comes to creating streams from a recruiter's existing projects.

A user, such as a recruiter, can resume an existing stream. For instance, this can be an entry point on the homepage of a recruiting tool to pick up an existing stream. A candidate stream can be referenced by a unique stream ID and can use the same review endpoint that grabs additional candidates to direct the user back into a stream. A stream can essentially be never ending. Whether the ranking model associated with the stream is updated offline or new candidates are re-exposed, unless explicitly deleted by the user, there should be relevant candidates available for that stream at any time.

A user, such as a recruiter, can also take actions on candidates. There are going to be a wide variety of actions that can be taken against a candidate in a stream. In an embodiment, only one of these actions will have a clear defined action. For example, in this embodiment, there are three statuses based on user feedback, all of which add the user to the same project: (1) Deferred: I'm not interested in this candidate right now, but they may be a hit at another time, (2) Interested: I'm interested in this candidate right now, I want to reach out to them immediately, and (3) Not Interested: I am not and will not be interested in this candidate. The Deferred feedback adds a candidate to the project with a skipped or deferred tag. This means they can be re-exposed later by the relevance engine. The Not Interested feedback means that the user is explicitly not interested in this candidate. There can be any number of factors behind this, but the underlying message is do not show the user this candidate again. The Interested feedback means that the user is interested in contacting this candidate. An embodiment validates this feedback against user testing, but this will either prompt the user to send a message (e.g., a Linkedin InMail message) right from the review screen of the recruiting tool or add them to a list to be contacted later. This same setup could be reorganized into multiple feedbacks and ratings, where different ratings align with some of these base indicators. For example, a star rating system where four or live stars indicates that a user is interested in a candidate, one or two stars means the user is not interested, and a three star rating means the user is deferring a decision.

In some embodiments, an offline technique evaluates the effect of explicit feedback on candidate ranking in an automated sourcing context. The technique can glean explicit feedback from review or log data of an automated sourcing recruiter tool. The technique can determine feedback based on impression data in log data from such a tool. An embodiment uses a simple ranking model that can be utilized offline to evaluate re-ranking due to feedback.

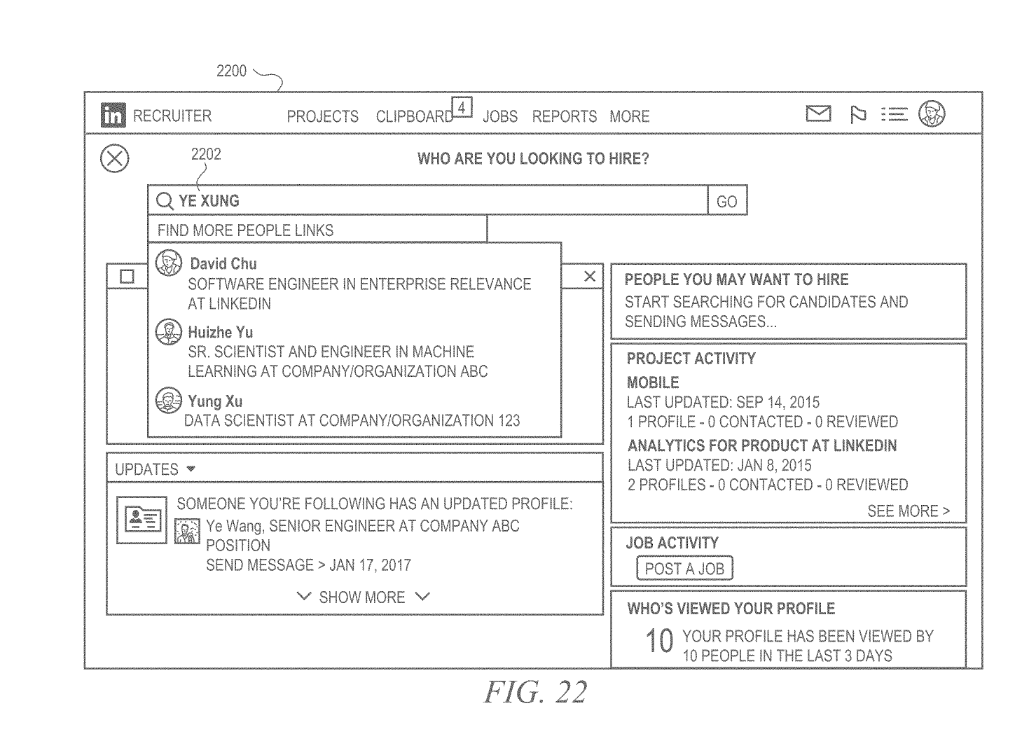

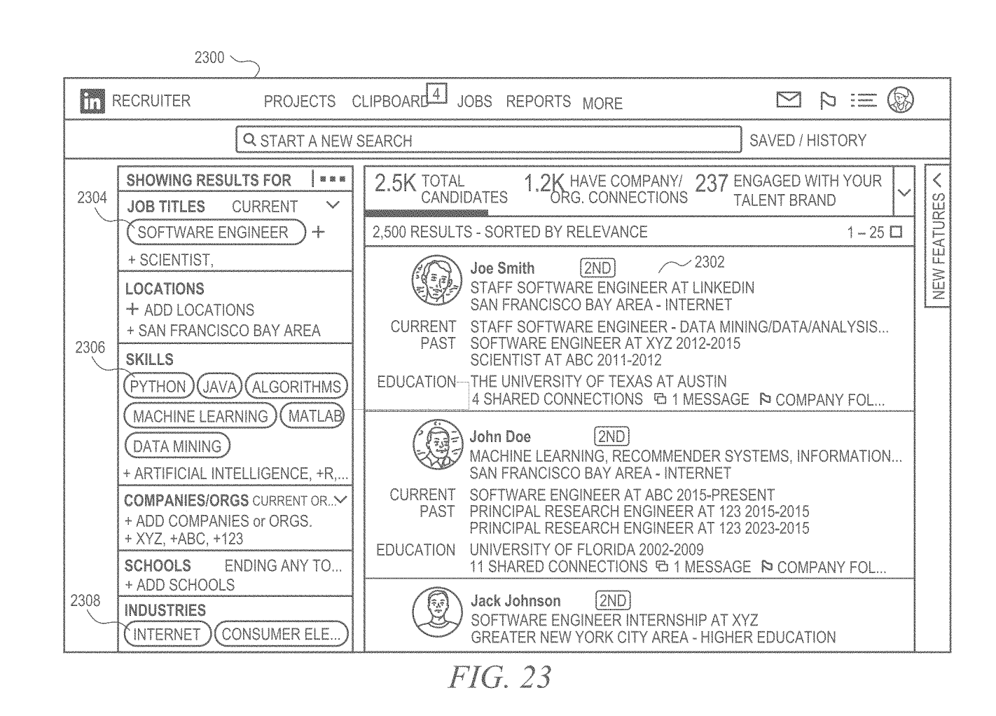

Example techniques utilize review data from a recruiter tool (see, e.g., the example recruiter tool user interface shown in FIGS. 22 and 23). Some embodiments also utilize standardized log data in a linked data set, which gives a more exhaustive context. This data set can include several years of review data (e.g., 8 years) as well as the skills, positions, and education features of the candidates at the time of the review. These techniques re-rank candidates via updating the ranking model in order to improve ranking metrics. For instance, ranking metrics measuring precision and NDCG can be improved by updating the ranking model. In the context of candidate feature ranking, NDCG is a metric measuring ranking quality of candidate features. In a streaming environment where candidate feature information is retrieved and presented to a user, NDCG can be used to measure effectiveness of a candidate query or search engine algorithms used by an automated sourcing recruiter tool or an intelligent matches application. For instance, by using a graded relevance scale of member profile documents in a recruiter tool result set, NDCG can measure the usefulness, or gain, of a particular member profile document based on its position in the result list. Candidate streams can be result lists that vary in length depending on the user's query. NDCG can be used to compare a recruiting tool's performance from one candidate query to the next. This is because NDCG can indicate the cumulative gain at each position for a chosen value that is normalized across candidate queries. This can be done by sorting all relevant member profile documents in the stream of candidates by their relative relevance, producing the maximum possible, or ideal discounted cumulative gain (IDCG). The re-ranking is based on a currently ranked candidate list and a given (or estimated) initial ranking algorithm. The systems and techniques disclosed herein use explicit feedback to improve relevance by enabling term weighting for search ranking.

According to certain embodiments, a method filters a data set for a candidate count in order to be able to evaluate online updates to the candidate ranks. Some of these embodiments use a certain number of initially ranked candidates as input. In additional or alternative embodiments, filtering can also be performed according to a total number of successful reviews and other feedback measurements. Feature selection is also performed. Initially, a method includes performing a manual feature selection. Such a manual feature selection can include a recruiter user making manual selections of desired seniority and skills for a candidate search. In general, the method obtains an informational feature vector for each candidate to incorporate into the ranking model. Next, the example method performs re-ranking and evaluation.

The re-ranking and evaluation can include performing a cold start of the ranking model with a first candidate and user feedback that the first candidate received. The ranking model is used to rank a pool of candidates (excluding the first candidate since it has already been used). Based on the current ranking of the candidates, the method retrieves the candidate with the highest rating. This can be done in the context of an online system that is presenting a candidate to the user based on the feedback it has received thus far. Using the feedback for the current candidate, and a feature vector representing the candidate to the ranking model, the method updates the ranking model.

Next, the method re-ranks the pool of candidates that have not yet been used according to the updated model. Then, the method repeatedly retrieves the candidate with the highest rating until all candidates in the pool have been exhausted.

To judge the effectiveness of the ranking model at selecting favorably rated candidates before unfavorably rated candidates, the method can include computing ranking metrics measuring precision and candidate feature weights.

The method can include implementing a simulated data flow for ingesting an initial ranking model and updating it, and then performing further iterations of the offline experimental simulations. These offline experimental simulations can employ different models, use a warm-start of models, and utilize different features.

Due to limitations on the number of candidates per job in some recruiter tool log data or review data, there is a possibility that the method may not be able to produce meaningful results utilizing only such log or review data. In such cases, an embodiment supplements log or review data with impression data from the recruiter tool. This embodiment can implement reinforcement learning using desired hires or ideal candidates, both in the context of automated sourcing.

Some embodiments use explicit and implicit feedbacks that are given by recruiter users, rather than other users such as hiring managers. These embodiments can potentially take less domain knowledge into account by not relying on feedback from an organization's hiring manager.

Certain embodiments incorporate feedback to update candidate rankings offline. For example, once viable candidates are obtained that match a specific search query (see, e.g., a query built using an intent query clustering technique), the relative ranking among those is further performed according to a score that is a weighted combination of the candidate features. In an embodiment, this score can be calculated using the following formula:

$$score ( ca \vec{n} {d}_{i} ) = \vec{w} • ca \vec{n} {d}_{i} = {\sum }_{j} {w}_{j} \cdot {cand}_{i , j} \qquad ( 1 )$$

In the above formula (1), a ‘good’ w vector gives higher scores to candidates (cand) which are estimated to receive good feedback (i.e., where a user such as a hiring manager is interested in the candidates). In this way, an online update for the weights gets the gradient of the w according to the actual feedback (y), to get as close as possible to it, by using the following formula:

\vec{w}^{f}=\vec{w}−α·(\vec{w}●ca\vec{n}dᵢ−y)·candᵢ (2)

An example technique overcomes an issue arising from the fact that the actual score (i.e., wX candᵢ) is not known. However, in accordance with the example technique, for the purposes of reinforcing the feedback, the actual score can be ignored. This means that a positive feedback for a particular candidate will enforce the weights of that particular candidate's features being increased. Conversely, a negative feedback for a particular candidate will enforce the weights of that particular candidate's features being decreased.

In the context of online learning, α in formula (2) above is referred to as the learning rate. This value, in general, is based on the time when a candidate ranking is updated. In certain embodiments, different methods for assigning α can be used. For instance, the learning rate α may be independent for each feature, as well as the same for the whole weight vector at each update step.

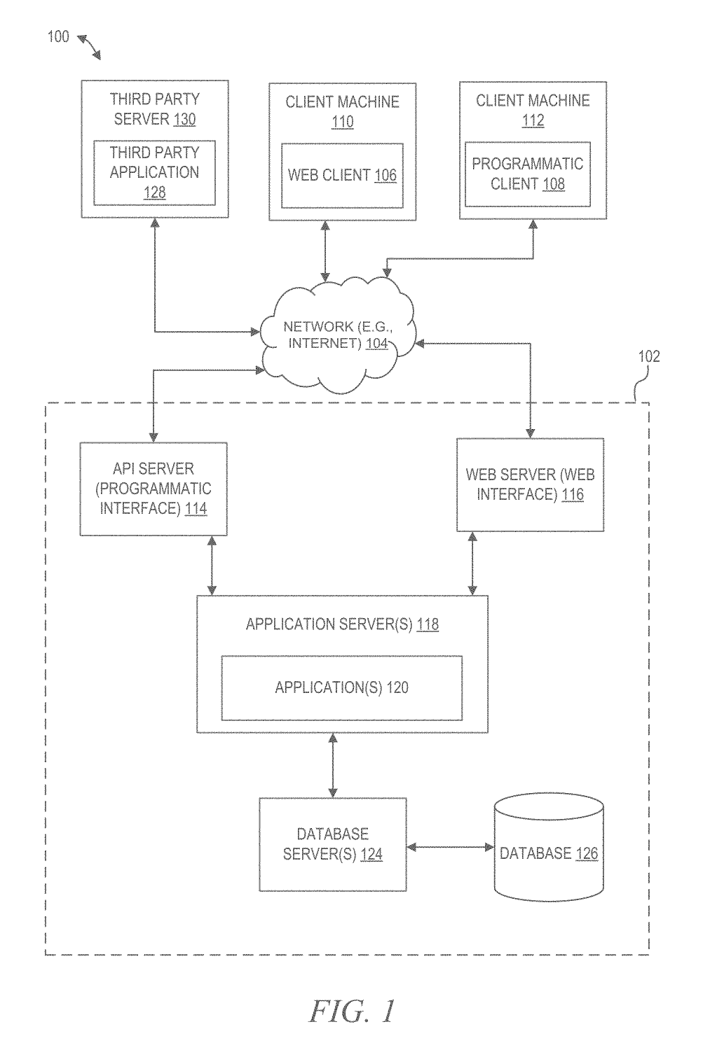

FIG. 1 is a block diagram illustrating a client-server system 100, in accordance with an example embodiment. A networked system 102 provides server-side functionality via a network 104 (e.g., the internet or a wide area network (WAN)) to one or more clients. FIG. 1 illustrates, for example, a web client 106 (e.g., a browser) and a programmatic client 108 executing on respective client machines 110 and 112.

An API server 114 and a web server 116 are coupled to, and provide programmatic and web interfaces respectively to, one or more application servers 118. The application server(s) 118 host one or more applications 120. The application server(s) 118 are, in turn, shown to be coupled to one or more database servers 124 that facilitate access to one or more databases 126. While the application(s) 120 are shown in FIG. 1 to form part of the networked system 102, it will be appreciated that, in alternative embodiments, the application(s) 120 may form part of a service that is separate and distinct from the networked system 102.

Further, while the client-server system 100 shown in FIG. 1 employs a client-server architecture, the present disclosure is, of course, not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the application(s) 120 via the programmatic interface provided by the API server 114.

FIG. 1 also illustrates a third party application 128, executing on a third party server 130, as having programmatic access to the networked system 102 via the programmatic interface provided by the API server 114. For example, the third party application 128 may, utilizing information retrieved from the networked system 102, support one or more features or functions on a website hosted by a third party. The third party website may, for example, provide one or more functions that are supported by the relevant applications 120 of the networked system 102.

In some embodiments, any website referred to herein may comprise online content that may be rendered on a variety of devices including, but not limited to, a desktop personal computer (PC), a laptop, and a mobile device (e.g., a tablet computer, smartphone, etc.). In this respect, any of these devices may be employed by a user to use the features of the present disclosure. In some embodiments, a user can use a mobile app on a mobile device (any of the machines 110, 112 and the third party server 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

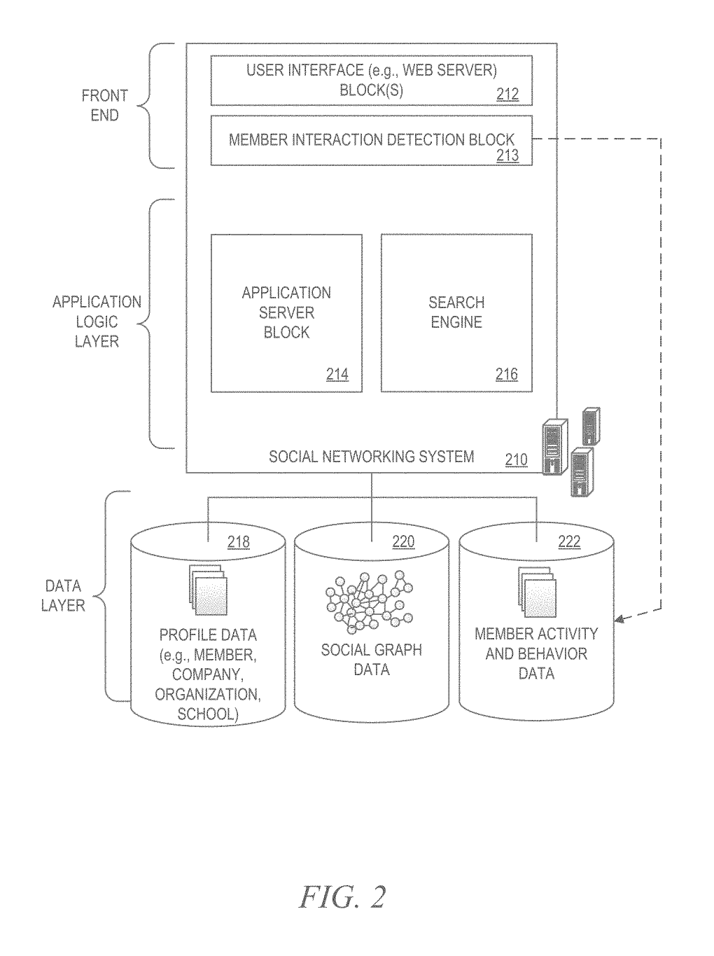

In some embodiments, the networked system 102 may comprise functional components of a social networking service. FIG. 2 is a block diagram showing the functional components of a social networking service, including a data processing block referred to herein as a search engine 216, for use in generating and providing search results for a search query, consistent with some embodiments of the present disclosure. In some embodiments, the search engine 216 may reside on the application server(s) 118 in FIG. 1. However, it is contemplated that other configurations are also within the scope of the present disclosure.

As shown in FIG. 2, a front end may comprise a user interface block (e.g., a web server 116) 212, which receives requests from various client computing devices, and communicates appropriate responses to the requesting client devices. For example, the user interface block(s) 212 may receive requests in the form of Hypertext Transfer Protocol (HTTP) requests or other web-based API requests. In addition, a member interaction detection block 213 may be provided to detect various interactions that members have with different applications 120, services, and content presented. As shown in FIG. 2, upon detecting a particular interaction, the member interaction detection block 213 logs the interaction, including the type of interaction and any metadata, relating to the interaction, in a member activity and behavior database 222.

An application logic layer may include one or more various application server blocks 214, which, in conjunction with the user interface block(s) 212, generate various user interfaces (e.g., web pages) with data retrieved from various data sources in a data layer. In some embodiments, individual application server blocks 214 are used to implement the functionality associated with various applications 120 and/or services provided by the social networking service.

As shown in FIG. 2, the data layer may include several databases, such as a profile database 218 for storing profile data, including both member profile data and profile data for various organizations (e.g., companies, government organizations, universities, schools, etc.). Consistent with some embodiments, when a person initially registers to become a member of the social networking service, the person will be prompted to provide some personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. This information is stored, for example, in the profile database 218. Similarly, when a representative of an organization initially registers the organization with the social networking service, the representative may be prompted to provide certain information about the organization. This information may be stored, for example, in the profile database 218, or another database (not shown). In some embodiments, the profile data may be processed (e.g., in the background or offline) to generate various derived profile data. For example, if a member has provided information about various job titles that the member has held with the same organization or different organizations, and for how long, this information can be used to infer or derive a member profile feature indicating the member's overall seniority level, or seniority level within a particular organization. In some embodiments, importing or otherwise accessing data from one or more externally hosted data sources may enrich profile data for both members and organizations. For instance, with organizations in particular, financial data may be imported from one or more external data sources and made part of an organization's profile. This importation of organization data and enrichment of the data will be described in more detail later in this document.

Once registered, a member may invite other members, or be invited by other members, to connect via the social networking service. A ‘connection’ may constitute a bilateral agreement by the members, such that both members acknowledge the establishment of the connection. Similarly, in some embodiments, a member may elect to ‘follow’ another member. In contrast to establishing a connection, the concept of ‘following’ another member typically is a unilateral operation and, at least in some embodiments, does not require acknowledgement or approval by the member that is being followed. When one member follows another, the member who is following may receive status updates (e.g., in an activity or content stream) or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within a social graph in a social graph database 220.

As members interact with the various applications 120, services, and content made available via the social networking service, the members' interactions and behavior (e.g., content viewed, links or buttons selected, messages responded to, etc.) may be tracked, and information concerning the members' activities and behavior may be logged or stored, for example, as indicated in FIG. 2, by the member activity and behavior database 222. This logged activity information may then be used by the search engine 216 to determine search results for a search query.

In some embodiments, the databases 218, 220, and 222 may be incorporated into the database(s) 126 in FIG. 1. However, other configurations are also within the scope of the present disclosure.

Although not shown, in some embodiments, the social networking system 210 provides an API block via which applications 120 and services can access various data and sen/ices provided or maintained by the social networking service. For example, using an API, an application may be able to request and/or receive one or more navigation recommendations. Such applications 120 may be browser-based applications 120 or may be operating system-specific. In particular, some applications 120 may reside and execute (at least partially) on one or more mobile devices (e.g., phone or tablet computing devices) with a mobile operating system. Furthermore, while in many cases the applications 120 or services that leverage the API may be applications 120 and services that are developed and maintained by the entity operating the social networking service, nothing other than data privacy concerns prevents the API from being provided to the public or to certain third parties under special arrangements, thereby making the navigation recommendations available to third party applications 128 and services.

Although the search engine 216 is referred to herein as being used in the context of a social networking service, it is contemplated that it may also be employed in the context of any website or online services. Additionally, although features of the present disclosure are referred to herein as being used or presented in the context of a web page, it is contemplated that any user interface view (e.g., a user interface on a mobile device or on desktop software) is within the scope of the present disclosure.

In an example embodiment, when member profiles are indexed, forward search indexes are created and stored. The search engine 216 facilitates the indexing and searching for content within the social networking service, such as the indexing and searching for data or information contained in the data layer, such as profile data (stored, e.g., in the profile database 218), social graph data (stored, e.g., in the social graph database 220), and member activity and behavior data (stored, e.g., in the member activity and behavior database 222). The search engine 216 may collect, parse, and/or store data in an index or other similar structure to facilitate the identification and retrieval of information in response to received queries for information. This may include, but is not limited to, forward search indexes, inverted indexes, N-gram indexes, and so on.

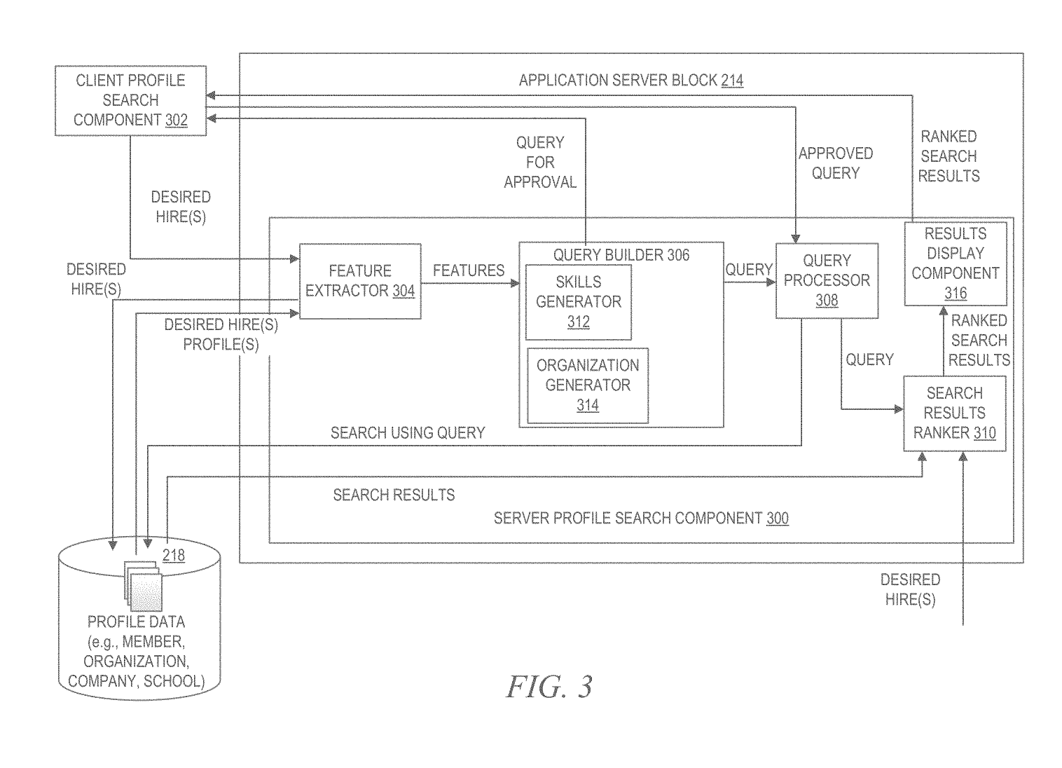

FIG. 3 is a block diagram illustrating the application server block 214 of FIG. 2 in more detail. While in many embodiments, the application server block 214 will contain many subcomponents used to perform various different actions within the social networking system 210, in FIG. 3 only those components that are relevant to the present disclosure are depicted. Here, a server profile search component 300 works in conjunction with a client profile search component 302 to perform one or more searches on member profiles stored in, for example, profile database 218. The server profile search component 300 may be, for example, part of a larger software service that provides various functionality to employers or recruiters. The client profile search component 302 may include a user interface and may be located on a client device. For example, the client profile search component 302 may be located on a searcher's mobile device or desktop/laptop computer. In some example embodiments, the client profile search component 302 may itself be, or may be a part of, a stand-alone software application on the client device. In other example embodiments, the client profile search component 302 is a web page and/or web scripts that are executed inside a web browser on the client device. Regardless, the client profile search component 302 is designed to accept input from the searcher and to provide visual output to the searcher.

In an example embodiment, the input, from the client profile search component 302 includes an identification of one or more desired hires for a job opening. This identification may be accomplished in many ways. In some example embodiments, the input may be an explicit, identification of one or more member profiles stored in the profile database 218. This explicit identification may be determined by the searcher, for example, browsing or otherwise locating specific profiles that the searcher feels are desired. For example, the searcher may know the identity of individuals on a team, in which the open position is available, and may navigate to and select the profiles associated with those team individuals. In another example embodiment, the searcher may create one or more hypothetical ‘desired hire’ profiles and use those as the input. In another example embodiment, the searcher may browse or search profiles in the profile database 218 using traditional browsing or searching techniques. In some example embodiments, the explicit identification may be provided by the job poster.

The server profile search component 300 may contain a feature extractor 304. The feature extractor 304 may be implemented as a system component or machine component that is configured to extract one or more raw features from one or more profiles of one or more desired hires (e.g., skills, organizations, titles, schools. industries, and other features from one or more desired hire member profiles). The feature extractor 304 extracts raw features, including, for example, skills, organizations, titles, schools, industries, and the like, from the profiles of the one or more desired hires. These raw features are then passed to a query builder 306. For each feature type, the query builder 306 aggregates the raw features across the input candidates, expands them to similar features, and finally selects the top features that best represent the desired hires.

After the query is generated, in an example embodiment, the generated query may be shown to the searcher via the client profile search component 302 and the searcher may have the opportunity to edit the generated query. This may include adding or removing some features, such as skills and organizations, in the query. As part of this operation, a query processor 308 may perform a search on the query and present raw results to the searcher via the client profile search component 302. These raw results may be useful to the searcher in determining how to edit the generated query.

In some example embodiments, refinement questions are presented to a searcher in order to refine a query. For instance, responses to refinement questions received from the searcher can be used to refine a generated query. In another example embodiment, a machine learning model is trained to make ‘smart suggestions’ to the searcher as to how to modify the generated query. The model may be trained to output suggestions based on any number of different facets, such as title, company or organization, industry, location, school, and skill.

Usage data can be gathered regarding actions taken by searchers when facing a suggestion— (1) add the suggestion, (2) delete the suggestion, or (3) ignore the suggestion. Intuitively, if a searcher adds a suggestion, it is probably a desired one and thus can be considered a positive training sample. If the searcher deletes the suggestion, then it is probably not a desired one and thus can be considered a negative training sample. For ignored suggestions, if the suggestion is positioned lower than an added suggestion (e.g. ‘Santa Clara University’ is positioned lower than added ‘University of California, Santa Cruz’), then it is not certain whether the suggestion is really ignored by searchers or useless in the setting of the query. Thus, this data can be ignored. If, however, the ignored suggestion is positioned higher than an added suggestion, it can be treated as negative data.

After the query is modified, the query processor 308 may refresh the search results. A search results ranker 310 may act to rank the search results, taking into account both the query (including potentially the generated query and the modified generated query) as well as the input desired hires when ranking the search results. The search results ranker 310 may be implemented as a system component or machine component that is configured to rank the search results according to one or more ranking algorithms. For example, the search results ranker 310 may rank one or more desired hire documents (e.g., member profiles of desired hires) based on ranking scores obtained by inputting one or more desired hire-based features extracted from the desired hire documents to a combined ranking model. The combined ranking model may be trained by a machine learning algorithm to output a ranking score for each of the desired hire documents. The combined ranking model may include weights assigned to each of the one or more extracted, desired hire-based features. A results display component 316 may receive ranked search results from the search results ranker 310 and present the ranked search results on a display device (e.g., a display screen of a computing device). As shown in FIG. 3, the ranked search results can be passed from the results display component 316 to the client profile search component 302.

Referring back to the query builder 306, given the raw features from the profiles of the desired hires, the query builder 306 generates a query containing skills, organizations, titles, and the like that best represents the desired hires.

The query builder 306 may comprise a skills generator 312 designed to generate skills to be added to the generated query. The social networking service may allow members to add skills to their profiles. Typical examples of skills that, for example, an information technology (IT) recruiter might search could be ‘search,’ ‘information retrieval,’ ‘machine learning,’ and the like. Members may also endorse skills of other members in their network by, for example, asserting that the member does indeed have the specified skills. Thus, skills may be an important part of members' profiles that showcase their professional expertise. A technical challenge encountered, however, is that desired hires may not explicitly list all of the skills they have on their profiles. Additionally, some of their skills may not be relevant to their core expertise. For example, an IT professional may list ‘nonprofit fundraising’ as a skill. The query builder 306 may also comprise an organization generator 314 designed to use collaborative filtering to find organization relationships (e.g., relationships between companies).

To overcome these challenges, expertise scores for the desired hire may be estimated based on explicit skills (skills the member has explicitly listed) as well as implicit skills (skills the member is likely to have, but has not explicitly linked).

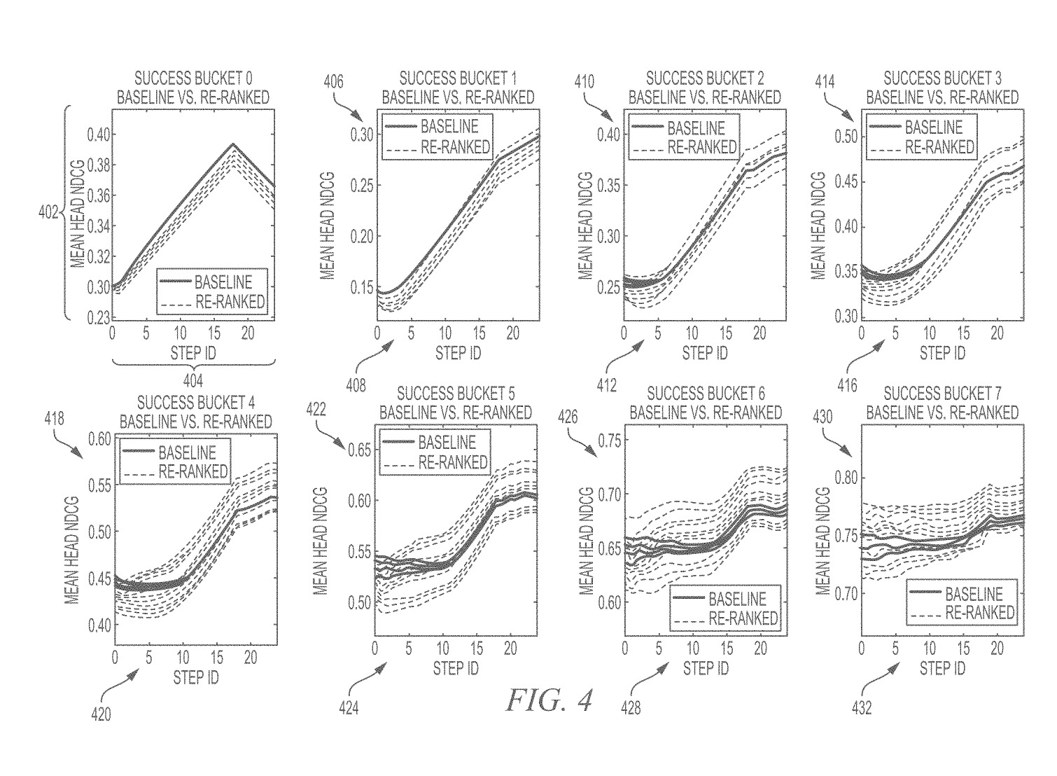

FIG. 4 depicts example results for online learning utilizing log data and review data from a recruiting tool. In an embodiment, the review data is over a period of multiple years (e.g., 8 years) and has the explicit response of hiring managers to the candidates that were forwarded to them. The preprocessing can standardize the review data to obtain the relevant positions, seniority (by utilizing standardized seniority strings), and education (by utilizing standardized degree strings) of the candidates at the time of the review. An embodiment can also select the skills of the candidate, but does not take a temporal snapshot. The candidate specific information can come from standardized data. After the preprocessing, there is a set of candidates per each job ID or project ID and a label assigned to them. In an embodiment, these labels can be great, maybe, and no.

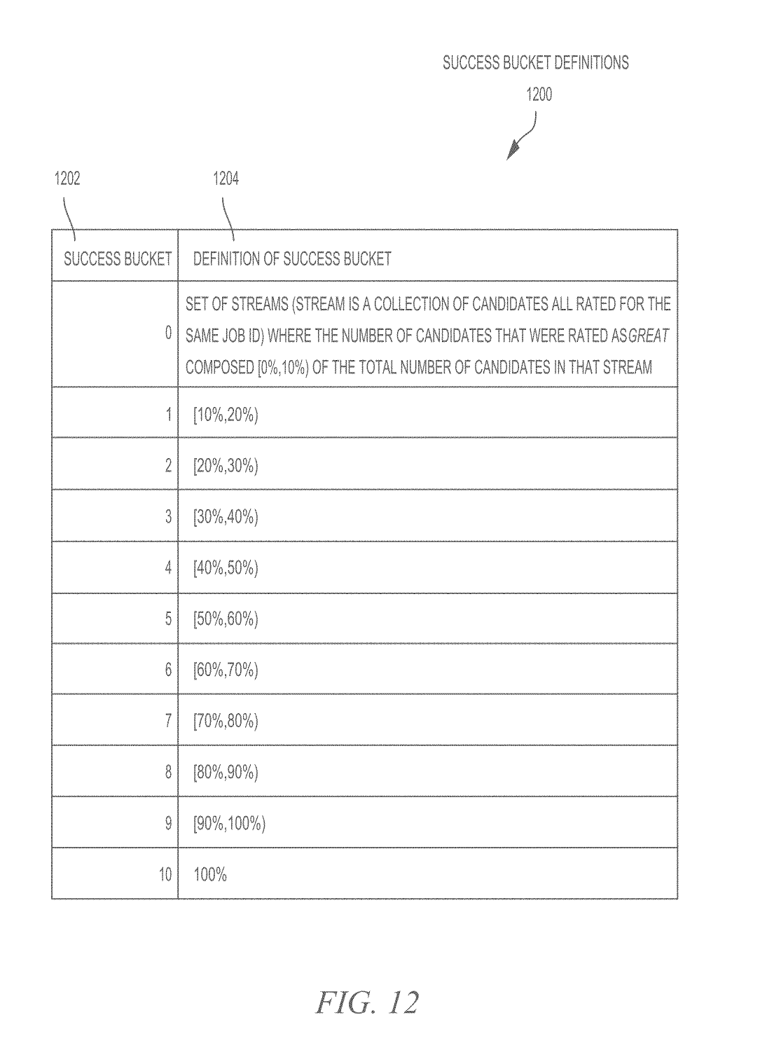

In the example of FIG. 4, each job stream (set of candidates all reviewed for the same job ID) has been separated into a success bucket, which indicates an interval for the great candidate percentage. Each bucket covers a 10% interval. For example, a job stream of 100 candidates, out of which 23 are labelled as great, has a great percentage of 23%, and falls into success bucket 2. (i.e., successBucket=floor (greatPercentage/10). See FIG. 12 for an example definition and mapping of success buckets.

After setting the success bucket and obtaining the candidate information for all streams, an embodiment applies an online learning simulation to estimate the potential online behaviour applying the online learning algorithm. This can be done by first randomizing the set of candidates into an arbitrary ordering (the aim is to show that re-ranking improves candidate quality) as the baseline. Then, the process starts with a model that assigns equal weight to each candidate feature, and at each step, the weights are updated according to the explicit and implicit user feedback. Each update causes the remaining candidates in the stream to be re-ranked. Next, the quality metrics (such as, for example, NDCG) are compared at each step. Since a significant number of candidates in the stream are needed for the ordering to be meaningful, a hard filtering of streams is performed to ensure that the streams have a certain range of candidates. In certain embodiments, the hard filtering of streams is performed to ensure that the streams have between 20 and 300 candidates. Example offline results are presented in FIGS. 4-11. However, these example results are meant to mimic the behaviour of an online application using the online learning algorithm. Some embodiments are based on applying term reweighting in an online recruiting application context.

FIG. 4 depicts overlaid candidate feature re-ranking results for parameters re-weighted based on feedback received in a streaming environment, in accordance with example embodiments. FIG. 4 shows the results of performing a set of experiments separately for each Success Bucket group (set of streams that fall into that bucket), and each experiment is for a specific parameter setting. FIG. 4 shows all the curves for all the parameter settings overlaid on each other. In FIG. 4, the range of step IDs 404, 408, 412, 416, 420, 424, 428, and 432 show the number of candidates at that point (re-ranked at each step). In FIG. 4, the mean head NDCG values 402, 406, 410, 414, 418, 422, 426, and 430 indicate the NDCG of the candidates shown up until the corresponding step. Hence, each curve in the graphs of FIG. 4 presents the mean head NDCG value over all streams falling into the success bucket at each step for a specific set of parameters. Example parameters are given in the following paragraphs.

While FIGS. 4-11 depict example offline results and evaluations, the techniques, methods, models, and algorithms described herein can be applied in an online manner to the users of a recruiter application. The type of parameters that can be used for the offline results depicted in FIGS. 4-11 can include the following:

ifPerFeatureLR—indicates if a different learning rate is calculated for each feature at each time step, or if a single learning rate is calculated for all features at each time step.

use Skills: indicates whether skills are used as candidate features.

useEducation: indicates whether degree is used as a candidate feature.

useSeniority: indicates whether seniority is used as a candidate feature.

alpha: Hyper parameter for calculating learning rate.

learningRateAlgorithm: Algorithm 1→alpha*1/t, where t is either the number of steps so far (if the same learning rate is calculated for all features at that step) or the number of times a feature has been seen till that step (if a different learning rate is calculated for each feature at that step). Algorithm 2→alpha*1/sqrt(t), where t definition is the same as in the case of Algorithm 1.

With continued reference to FIG. 4, several graphs are shown that plot overlaid results for all parameters in feedback experiments for success buckets 0 through 7. The first pattern emerging across the success buckets of FIG. 4 is that the re-ranking seems to be working better for higher success rates. That is, re-ranking exceeds the baseline. This is due to the fact that there is a higher number of positive signals and more chances for re-ranking to bring up values. Secondly, FIG. 4 illustrates that no matter how much new feedback is applied, the model parameters play an important role in improving on the baseline ordering of candidates.

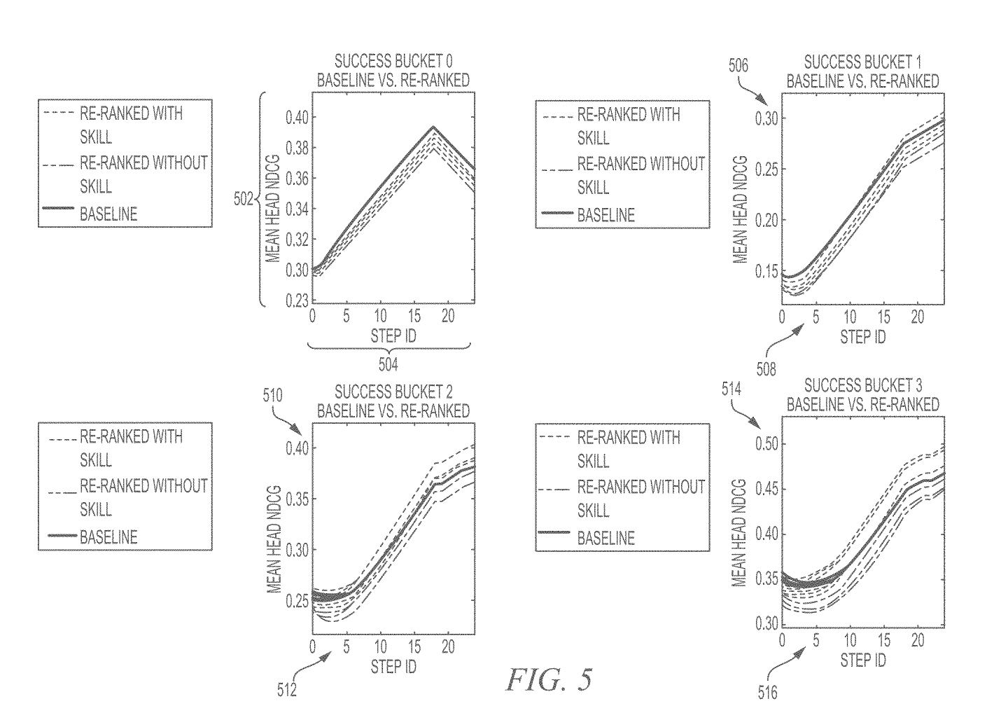

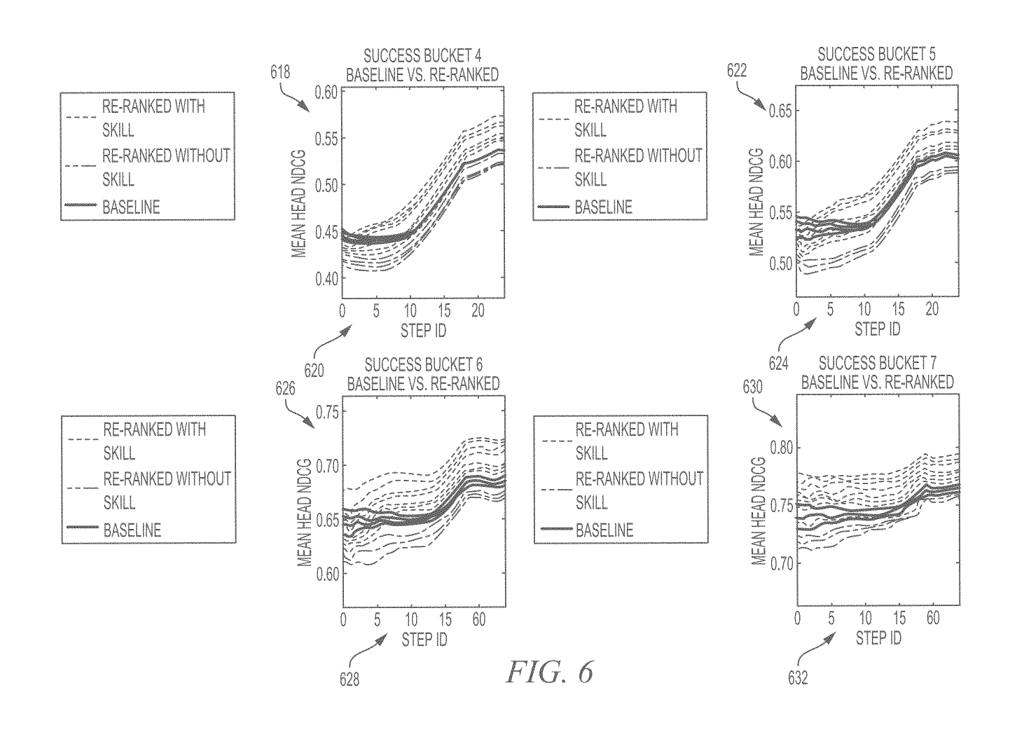

FIGS. 5 and 6 depict overlaid candidate feature re-ranking results for parameters, with graphs comparing re-ranking utilizing candidate skill features to re-ranking without utilizing skill features.

In particular, FIG. 5 shows example results for candidates re-ranked based on skills parameters (e.g., skills indicated in candidate member profiles). In FIG. 5, the range of step IDs 504, 508, 512, and 516 show the number of candidates at that point (as aforementioned, re-ranked at each step). In FIG. 5, the mean head NDCG values 502, 506, 510, and 514 indicate the NDCG of the candidates shown up until the corresponding step ID. Similarly, in FIG. 6, the range of step IDs 620, 624, 628, and 632 show the number of candidates at that point (re-ranked at each step). In FIG. 6, the mean head NDCG values 618, 622, 626, and 630 indicate the NDCG of the candidates shown up until the corresponding step. Hence, curves in the graphs of FIGS. 5 and 6 present the mean head NDCG value over all streams falling into the success bucket at each step for a specific set of parameters that include candidate skills. FIGS. 5 and 6 illustrate how candidate skills is the most useful feature in feedback signals as the session proceeds for re-ranking. As shown in the graphs of FIGS. 5 and 6, there is a clear pattern that candidates tend to perform significantly better than baseline when utilizing skills of candidates, and below baseline when re-ranking does not take candidate skills into account.

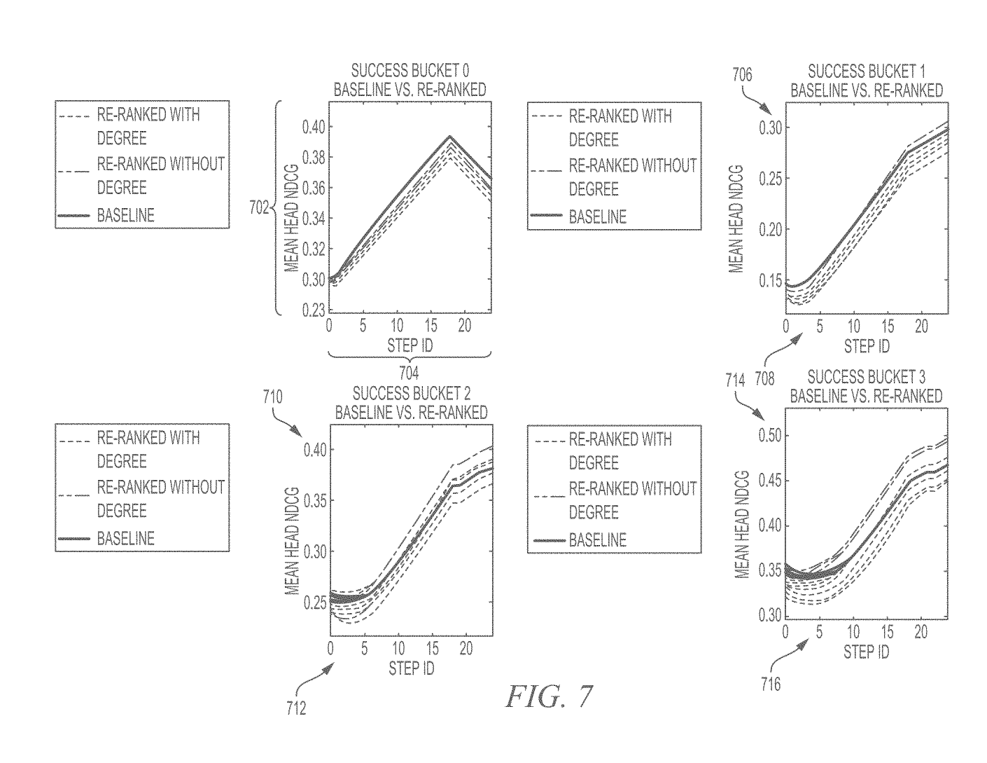

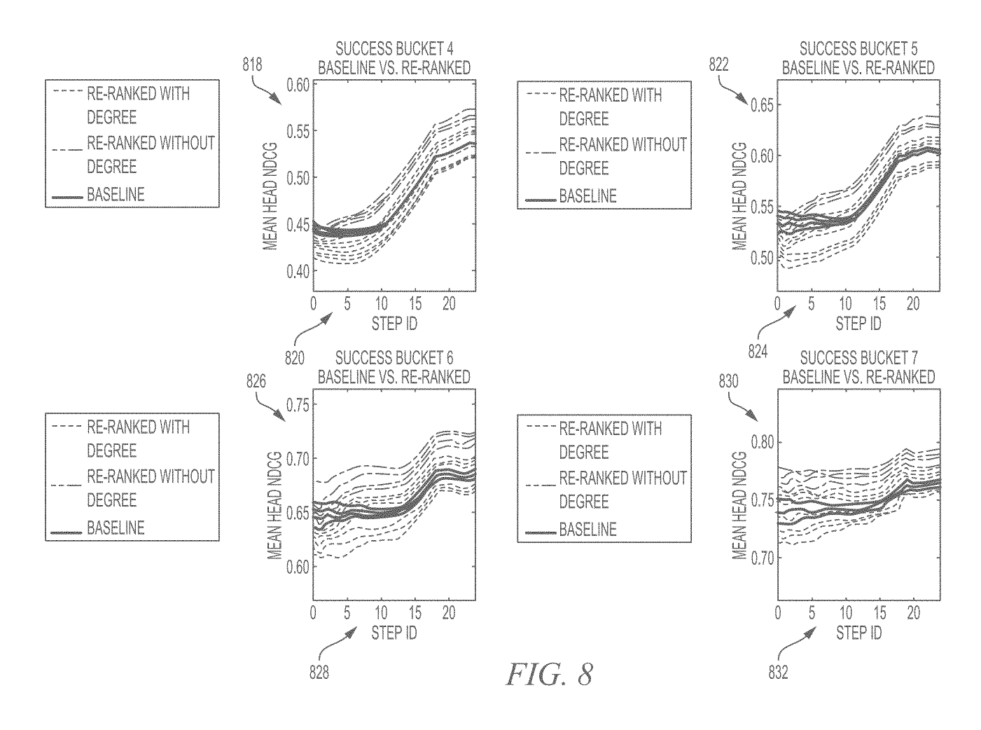

FIGS. 7 and 8 depict overlaid candidate feature re-ranking results for parameters, with graphs comparing re-ranking utilizing candidate education to re-ranking without utilizing education.

In particular, FIGS. 7 and 8 illustrate example results for candidates re-ranked based on education parameters (e.g., educational degrees indicated in candidate member profiles). As shown in the graphs of FIGS. 7 and 8, utilizing education features in terms of the degrees that a candidate has achieved introduces significant noise to the ranking quality, and the graphs show that results are much better when education features are not used. In FIG. 7, the range of step IDs 704, 708, 712, and 716 show the number of candidates at that point (re-ranked at each step). In FIG. 7, the mean head NDCG values 702, 706, 710, and 714 indicate the NDCG of the candidates shown up until the corresponding step ID. Also, FIG. 8 shows that the range of step IDs 820, 824, 828, and 832 indicate the number of candidates at that point (again, re-ranked at each step). In FIG. 8, the mean head NDCG values 818, 822, 826, and 830 indicate the NDCG of the candidates shown up until the corresponding step. Hence, curves in the graphs of FIGS. 7 and 8 present the mean head NDCG value over all streams falling into the success bucket at each step for a specific set of parameters that include candidate education (e.g., degrees obtained).

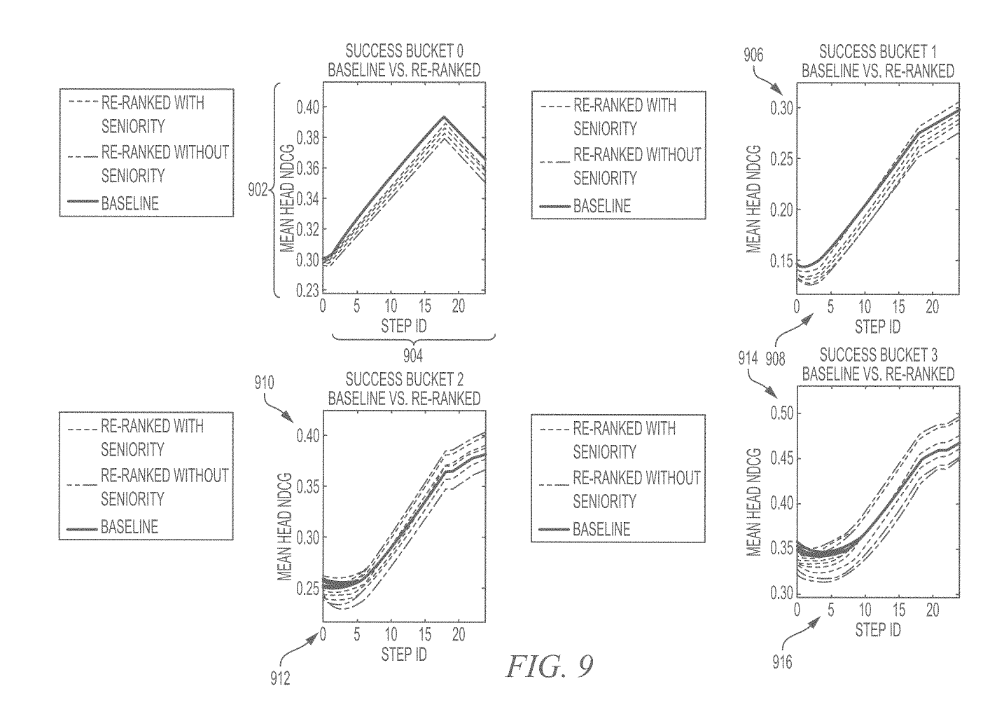

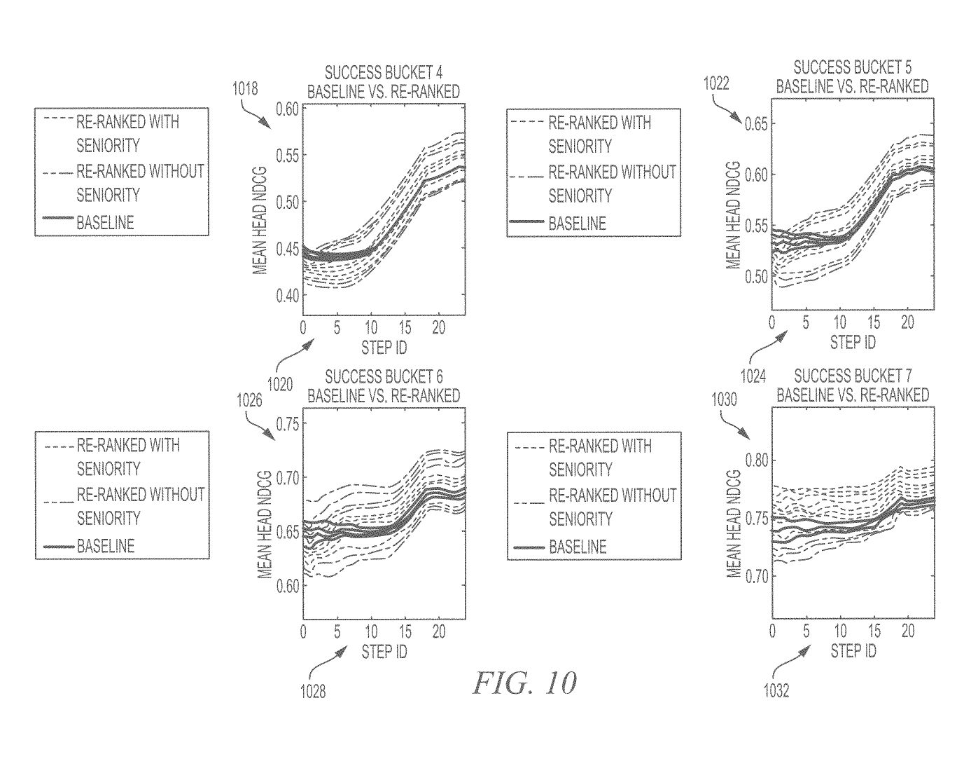

FIGS. 9 and 10 depict overlaid candidate feature re-ranking results for parameters, with graphs comparing re-ranking utilizing candidate seniority to re-ranking without utilizing seniority. As shown in FIGS. 9 and 10, utilizing seniority features (e.g., seniority or tenure of positions a candidate has held in other organizations and companies until the time of the review) has a mixed effect in terms of other parameters chosen with it. In FIG. 9, the range of step IDs 904, 908, 912, and 916 show the number of candidates at that point (re-ranked at each step). In FIG. 9, the mean head NDCG values 902, 906, 910, and 914 indicate the NDCG of the candidates shown up until the corresponding step ID. Additionally, FIG. 10 shows that the range of step IDs 1020, 1024, 1028, and 1032 indicate the number of candidates at that point (again, re-ranked at each step). In FIG. 10, the mean head NDCG values 1018, 1022, 1026, and 1030 indicate the NDCG of the candidates shown up until the corresponding step ID. While FIG. 10 shows results that are consistently above baseline for some parameter selections in higher success buckets (even in these cases, an embodiment can also utilize skills in conjunction with seniority features), the graphs of FIGS. 5-6 and 9-10 also show that utilizing only skills (without Seniority) seems to perform better.

In some embodiments, utilizing the learning rate method alpha=(1/sqrt) often gives better results due to learning more aggressively in later steps compared to a linear learning rate such as alpha=(1/n).

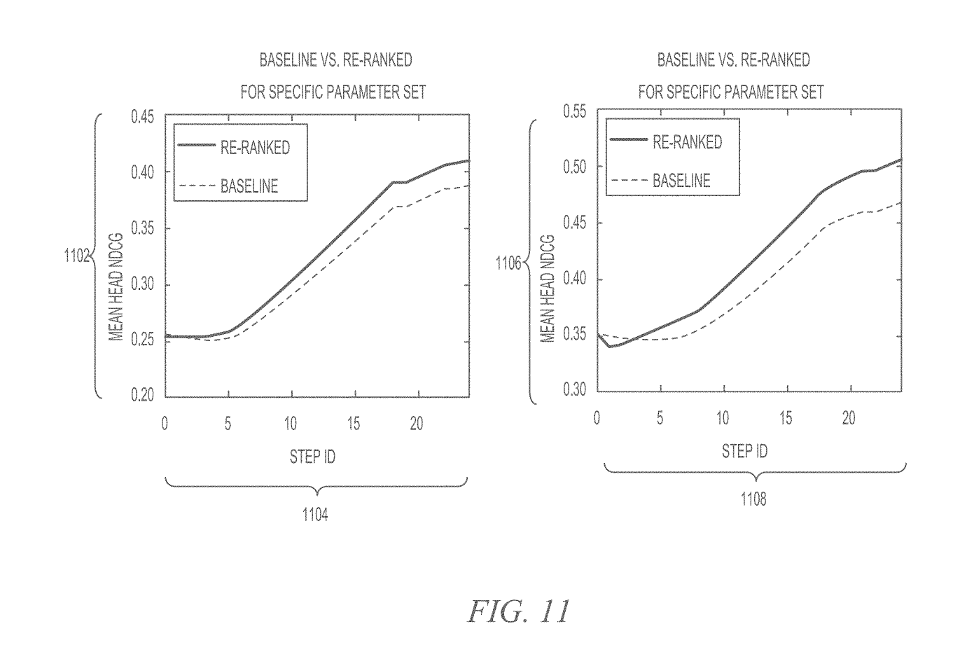

FIG. 11 depicts NDCG improvement for a set of candidates as compared to a baseline. FIG. 11 depicts specific cases to see micro-behavior for a specific parameter set. In FIG. 11, graphs depict results of two specific experiments (with a specific set of parameters), where there is around 10% NDCG improvement for mean NDCG values 1102 and 1106 in as a session progresses across steps in step ID ranges 1104 and 1108 as compared to the baseline. One interesting observation is from FIG. 11, where there is a dip in the mean head NDCG 1106 after the first candidate (updating our model based on that feedback, and re-ranking the remaining set of candidates). This demonstrates the convergence behavior, where, as more and more candidates are received (and feedback for them is received), the ranking model gets better and the results surpass the baseline significantly due to the online learning.

With continued reference to FIG. 11, the mean head NDCG results 1102 and 1106 over the steps in step ranges 1104 and 1108 are shown within session for specific parameters. In FIG. 11, success bucket 2, with mean head NDCG results 1102 and step range 1104, is the result of utilizing both skills and seniority. This is the result of utilizing a version 2 of the learning rate formula, and the same learning rate for each feature, recalculated at each step for re-ranking. Also in FIG. 11, success bucket 3 is shown with mean head NDCG results 1106 across step range 1108. This is the result of utilizing only the skills feature and utilizing a version of the learning rate formula where alpha=(1/n), and the same learning rate for each feature, recalculated at each step for re-ranking.

FIG. 12 is a table listing success bucket definitions. In particular, FIG. 12 lists Success Buckets 1202 used in the experiments and results depicted in FIGS. 4-11 and their corresponding success bucket definitions 1204.

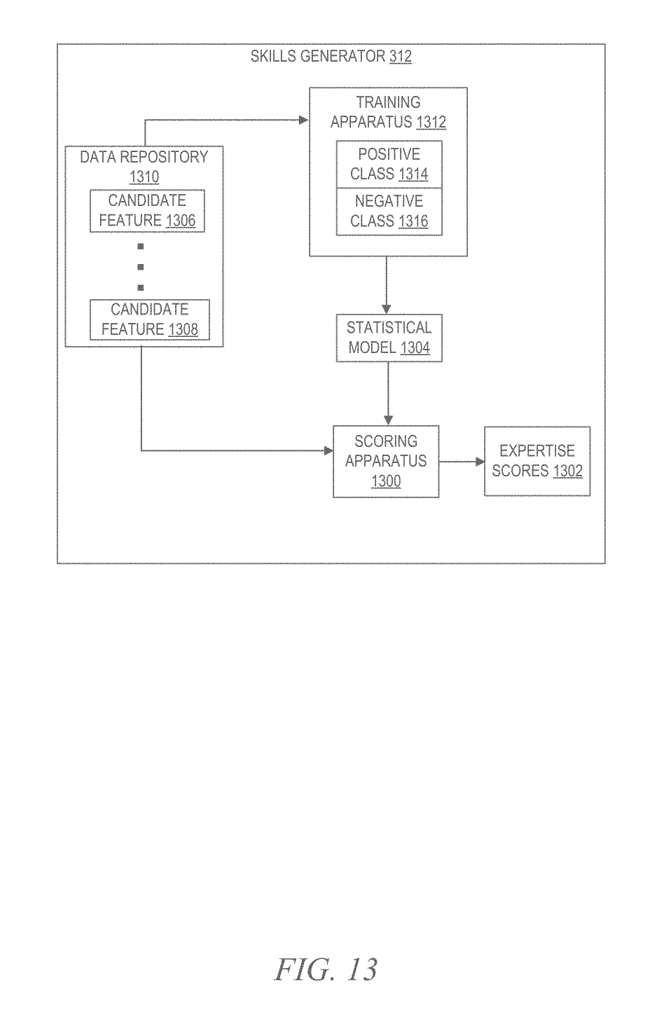

FIG. 13 is a block diagram illustrating the skills generator 312 in more detail, in accordance with an example embodiment. As shown in FIG. 13, a scoring apparatus 1300 may calculate a set of expertise scores 1302 using a statistical model 1304 and a set of candidate features 1306-1308 for candidate member profiles. Candidate features 1306-1308 may be aggregated into a data repository 1310 from the member profiles and/or user actions. For example, candidate features 1306-1308 may be received from a number of servers and/or data centers associated with the websites and/or applications and stored in a relational database for subsequent retrieval and use.

Prior to calculating expertise scores 1302 on actual member profiles, a training apparatus 1312 may obtain training data for statistical model 1304, which includes a positive class 1314 and a negative class 1316. Positive class 1314 may include data associated with items of a particular category (e.g., trait, feature, dimension, etc.), while negative class 13 16 may include data associated with items that do not belong in the category.

For example, statistical model 1304 may be a logistic regression model that classifies each member profile as either an expert or a non-expert in a corresponding skill. Positive class 1314 may thus include a subset of candidate features 1306-1308 associated with members with known expertise in one or more skills. Such ‘expert’ members may be identified based on publications, speeches, awards, and/or contributions of the users in their respective fields. On the other hand, negative class 1316 may include a subset of candidate features 1306-1308 associated with members who are not recognized as experts in their respective fields, such as random members who list a given skill in their profiles. Because far fewer users belong in positive class 1314 than negative class 1316, positive class 1314 may be oversampled to produce a roughly class-balanced set of training data for statistical model 1304.

Next, training apparatus 1312 may use positive class 1314 and negative class 1316 to train statistical model 1304. For example, training apparatus 1312 may use maximum-likelihood estimation (MLE) and/or another estimation technique to estimate the parameters of a logistic regression model for calculating expertise scores 1302. After training of the logistic regression model is complete, the parameters may be set so that the logistic regression model outputs values close to 1 for training data in positive class 1314 and values close to 0 for training data in negative class 1316.

The trained statistical model 1304 may be provided to scoring apparatus 1300, which calculates expertise scores 1302 for member profiles not included in the training data (such as desired member profiles supplied by the searcher) by applying statistical model 1304 to features (e.g., candidate features 1306-1308) for each of the items. For example, a feature vector may be generated for each item from a subset of candidate features 1306-1308 in data repository 1310, and statistical model 1304 may be applied to the feature vector to calculate an expertise score for the item with respect to a dimension of the member profile.

Candidate features 1306-1308 used in the calculation of expertise scores 1302 may include demographic features, social features, and behavioral features. Demographic features may include data related to a member's location, age, experience, education, and/or background, social features may include features related to the behavior of other users with respect to the user; and behavioral features may include features related to the member's actions or behavior with the online professional network and/or related websites or applications.

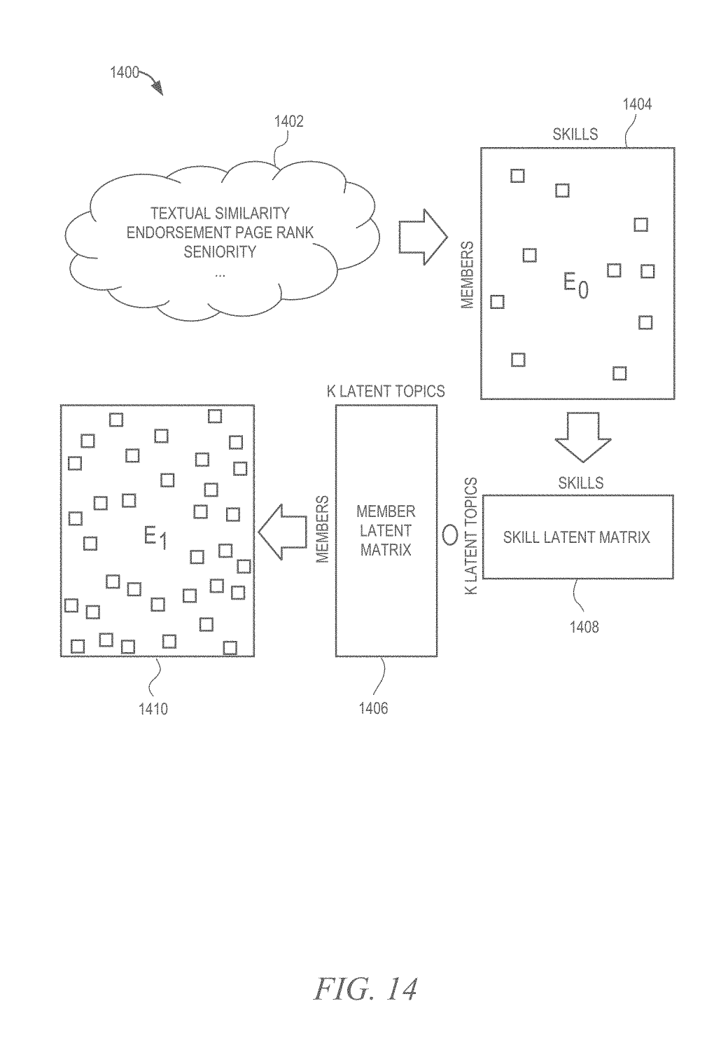

FIG. 14 is a diagram illustrating an offline process 1400 to estimate expertise scores, in accordance with another example embodiment. A supervised machine learning algorithm combines various signals 1402, such as skill-endorsement graph page rank, skill-profile textual similarity, member seniority, and the like to estimate the expertise score. After this step, a formed expertise matrix 1404 is very sparse since only a small percentage of the pairs can be predicted with any degree of certainty. Expertise matrix 1404 may be factorized into member matrix 1406 and skill matrix 1408 in K-dimensional latent space. Then, the dot-product of the expertise matrix 1404 and skill matrix 1408 is computed to fill in the ‘unknown’ cells. The intuitive correlation is that the more members who list two particular skills in their corresponding member profiles (called co-occurrence of skills), the more likely it is that a member only listing one of those skills also has the other skill as a latent skill. Since the dot-product results in a large number of non-zero scores of each member on the skills, the scores can then be thresholded such that if the members score on a skill is less than a particular threshold, the member is assumed not to know the skill and is assigned a zero expertise score on the skill. Thus, the final expertise matrix 1410 is still sparse, but relatively much denser than formed expertise matrix 1404.

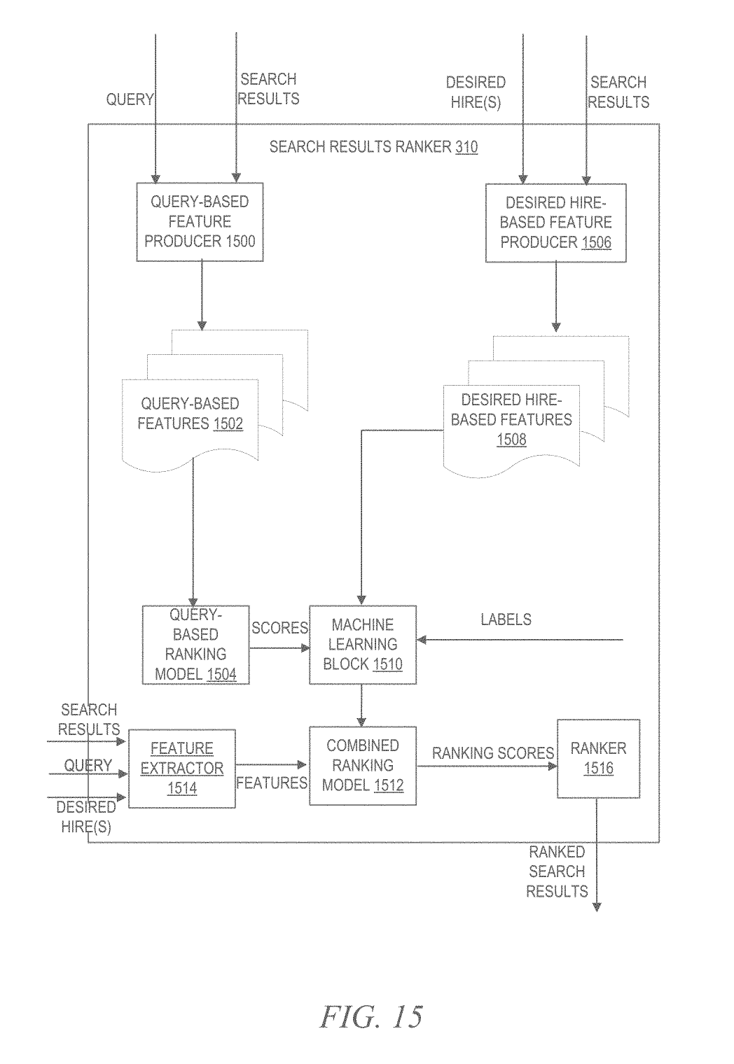

FIG. 15 is a block diagram illustrating the search results ranker 310 in more detail, in accordance with an example embodiment. The search query that produced the search results, as well as the search results, may be fed to a query-based feature producer 1500, which produces a set of query-based features 1502 of the results. Query-based features 1502 include search engine features such as term frequency-inverse document frequency (TF-IDF), term location in document, bag-of-words, and the like. These query-based features 1502 may be fed to a query-based ranking model 1504, which returns scores for each of the query/result pairs.

Separately, a desired hire (DH)-based feature producer 1506 receives as input the specified desired hire(s) and the search results from the query generated by the desired hire(s). The desired hire (DH)-based feature producer 1506 then produces a set of desired hire-based features 1508 of the results. Desired hire-based features 1508 include features that are based on a comparison of desired hires and the search results (each feature measures one desired hire/search result pair). Example candidate-based features include skill similarity, headline matching, headline similarity, and browsemap similarity.

At the node (position) level, similarity can then be ascertained by using a generalized linear model, although in other embodiments other approaches could be substituted. Then, at the sequence (profile) level, a sequence alignment method may be employed to find an optimal or near-optimal alignment between pairs of nodes from the two career paths.

Various schemes may be used to model the node corresponding to a job position, including sequence of positions and sequence of compositions. In the sequence of positions scheme, each node represents one particular position of the member's professional experience. In the sequence of compositions scheme, for each node, in addition to using position information, transition information is also incorporated between the given position and the previous one. In other words, the position information and the transition-related information together comprise the node. Transition information, such as whether title changes in this transition, whether organization changes, how the seniority changes, and the time in this transition, enhances the representation of this scheme by further disclosing information of the changing trend between a previous and a given position.

Skill similarity is a measure of similarity of the skill set of the desired hire and the skill set of the search result. It should be noted that skill sets may include skills that are explicit (e.g., specified by the member in their member profile) or implicit (e.g., skills that are similar to skills specified by the member in their member profile, but not explicitly listed).

Headline matching is a measure of the similarity between the query and the headline of each result. Notably, this is based on a text-based comparison and is not strictly desired hire-based. A headline is one or more visible fields (along with name) displayed as a search result snippet for a search result. While the concept of creating snippets for each search result is a topic that is beyond the scope of the present disclosure, such snippets often include a headline that helps explain why the result is relevant and likely to trigger actions from the searcher. The headline matching feature, therefore, measures the similarity between the query and this headline from the search result's snippet.

Headline similarity is a measure of the similarity between a headline of the desired hire and the headline of the search result. This similarity calculation may be performed with or without considering word semantics. In example embodiments where word semantics are not considered, a word2vec algorithm may be utilized. Word2vec is a group of related models used to produce word-embeddings. The word-embeddings are shallow, two-layer neural networks that are trained to reconstruct linguistic contexts of words. The neural network is shown a word and guesses which words occurred in adjacent position in an input text. After training, word2vec models can be used to map each word to a vector of typically several hundred elements, which represent that word's relation to other words.

Browsemap similarity is a measure of whether and how much other members/searchers/browsers visited both the desired hire's profile and the search result's profile in the same browsing session. The intuitive correlation is that if previous members/searchers/browsers viewed both profiles in the same session, then there is a higher likelihood that the profiles are similar, and thus that the underlying desired hire and search result are similar.

The desired hire-based features 1508 may be fed along with the scores from the query-based ranking model 1504 to a machine learning block 1510 (e.g., a machine learning algorithm). The machine learning block 1510 is a machine component designed to train a combined ranking model 1512 that is capable of determining a ranking score for a search result at runtime. This training may use labels supplied for training data (e.g., training desired hires and training search results along with labeled scores for each). The training may involve the machine learning block 1510 learning which features/scores are more or less relevant to the ranking scores and appropriately weighting such features and scores for runtime computations. At runtime, a feature extractor 1514 extracts both query-based and desired hire-based features from the query, search results, and desired hires and feeds these features to the combined ranking model 1512, which produces the scores as per its model. A ranker 1516 then uses these ranking scores to rank the search results for display to the searcher.

It should be noted that since searching by desired hires is a new concept, it is difficult to generate labeled data directly from a log of previous search systems, as would typically be done to generate labeled data. Instead, in an example embodiment, labeled data is generated from the log of a query-based search. One such log is a log of electronic communications performed after the search. For example, if a searcher sees 20 results to a query-based search for candidates, and sends email communications to 8 candidates from the 20 results, then it may be assumed that these 8 candidates are similar enough to be considered for the same job, and thus if a profile for one or more of those 8 candidates had been submitted for a search by desired hire, the other candidates could be considered likely top results. In an example embodiment other actions taken with respect to previous search results may be logged and similarly used to determine desired hire matches. For example, while communication with a candidate may be considered as strongly indicative of a match for the underlying position (and thus a match with other candidates also emailed for the same position) and assigned a high relevance score, clicking on a candidate (without an email) may be considered to be a partial match and may be assigned a moderate relevance score, while skipped results might be considered a low relevance score. The relevance scores may be used as the labels for the sample data.

Thus, in an example embodiment, communications between searchers and members of the social network service are monitored and logged and these communications are used to derive a label score for each sample search result/desired hire pair (the sample search results may simply be the search results presented in response to previous queries). The label score may be generated using various combinations of the metrics described above. For example, if the same searcher communicated with both candidates A and B in response to the same search query, then candidate B is assigned a score of 5 (on a scale of 1 to 5, 5 being most relevant) for a desired hire A and candidate A is assigned a score of 5 for a desired hire B. Actions such as clicking on a candidate that indicate a moderate relevance may be assigned a score of 3 and no action may be assigned a score of 1. Scores for various log entries can then be combined and averaged. The result is profile pairs that have been assigned a score of between 1 and 5 based on previous actions or inactions by previous searchers. These label scores may then be used as labels for hypothetical desired hire/search result pairs for those same member profiles.

In an example embodiment, a dynamic weight trainer is introduced into the architecture of FIG. 15 in order to dynamically alter the weights assigned to the DH-based features 1508. Specifically, a search query need not be limited to a single query and then the search is complete. Often the searcher may interact with the original query and search result to provide additional refinements of the original search. This is true not only with traditional text-based searches but also can be true with desired hire-based searches as well. This may be accomplished by the searcher applying additional filters and or making text-based additions to the initial desired hire-based search to refine the results. The result is that the role of the desired hire-based features, which directly measure the similarity between the desired hire(s) and the search results, becomes less and less important as the search is refined.

At the same time, as the search session continues, the confidence of the remaining features (e.g., query-based features) increase in usefulness.

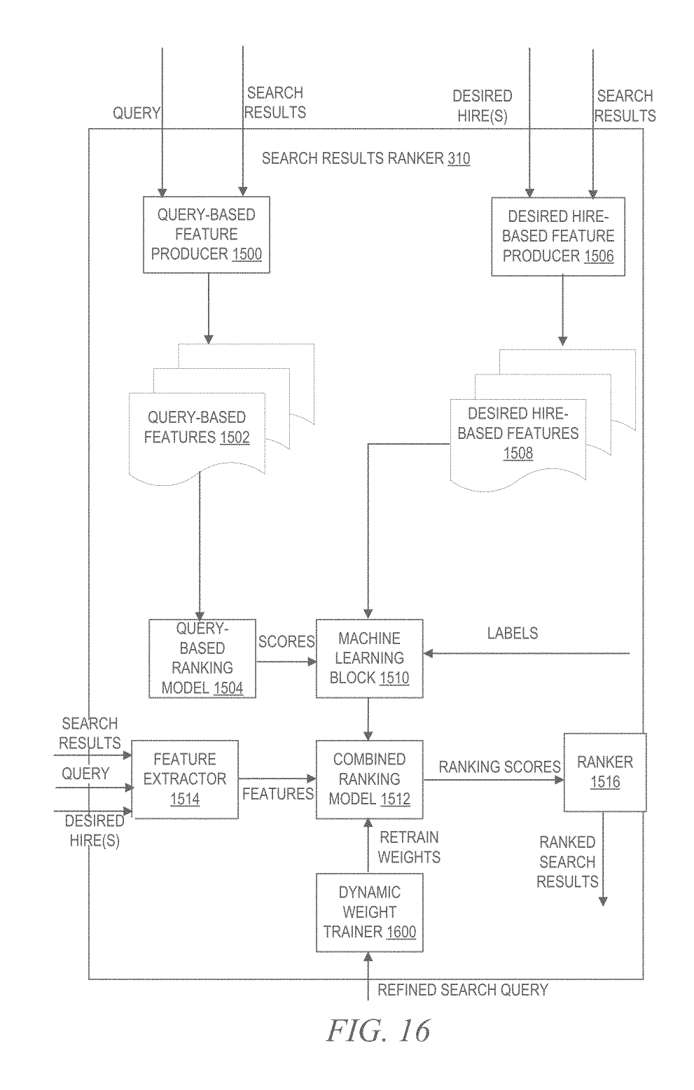

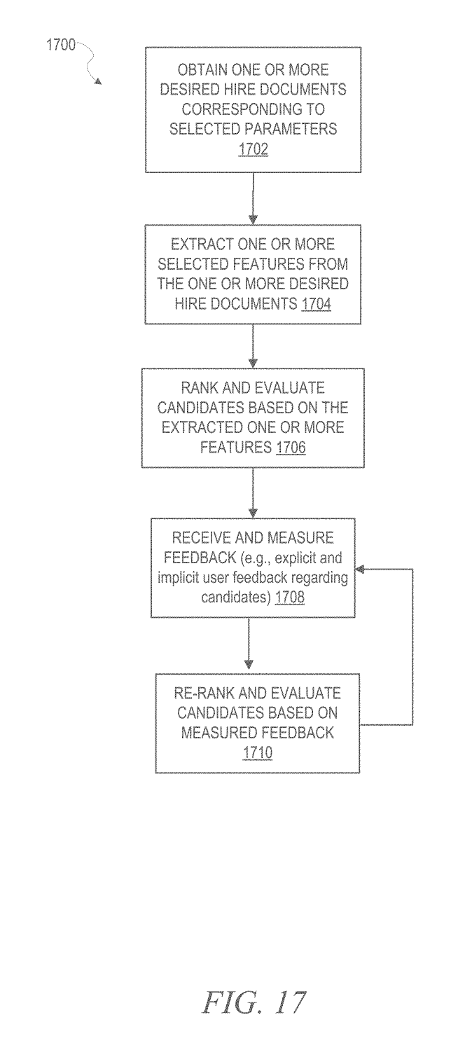

FIG. 16 is a block diagram illustrating the search results ranker 310 in more detail, in accordance with another example embodiment. FIG. 16 is identical to FIG. 15 with the exception of the addition of a dynamic weight trainer 1600. The purpose of the dynamic weight trainer 1600 is to dynamically alter the weights of the features extracted to favor the query-based features 1502 over the desired hire-based features 1508 over time. This may be performed by applying a decay function, defined on some measure of session length, such as the number of query refinements, to gradually reduce the weights of the desired hire-based features 1508 and/or increase the weights of the query-based features 1502. This function controls the dynamic balance between the impacts of the input desired candidates and the query on the result ranking. FIG. 17 is a flow diagram illustrating a method 1700 for performing a desired hire-based search, in accordance with an example embodiment. At operation 1702, one or more desired hire documents may be obtained. In an example embodiment, these documents are member profiles in a social networking service and they are obtained by a searcher specifying one or more parameters corresponding to member features (e.g., skills, organizations, education/degrees, and seniority), with the member profiles being retrieved from a database based on the searcher's specified parameters. However, implementations are possible where the documents obtained are not member profiles. In additional or alternative embodiments, the desired hire documents are member profiles corresponding to a stream of candidates. Initially, the method 1700 can include performing a manual feature selection as pan of operation 1702. Such a manual feature selection can Include a recruiter user making manual selections of desired seniority and skills for a candidate search.

At operation 1704, one or more candidate features are extracted from the one or more desired hire documents. According to certain embodiments, the operation 1704 also filters the data set for a candidate count in order to be able to evaluate online updates to the candidate ranks. Some of these embodiments use a certain number of initially ranked candidates as input. In additional or alternative embodiments, filtering can also be performed according to a total number of successful reviews and other feedback measurements. Feature selection can also performed as part of operation 1704. In an embodiment, operation 1704 obtains an informational feature vector for each candidate represented in the desired hire documents to incorporate into the ranking model.

At operation 1706, candidates represented by the one more desired hire documents are ranked and evaluated based on the extracted one or more features. The Initial rankings obtained by performing operation 1706 can be presented to a user as candidate documents (e.g., member profiles or summaries for candidates) in a candidate stream.

At operation 1708, feedback regarding presented candidate documents is received and measured. As shown, operation 1708 can include receiving explicit and implicit user feedback. The feedback can be feedback from a user such as a recruiter or hiring manager. Here, the desired hire documents may be member profiles in a social networking service.

Explicit feedback received at operation 1708 can include acceptance, deferral, or rejection of a presented candidate by a user (e.g., recruiter feedback). Explicit feedback received at operation 1708 can also Include a user's interest in member urns and can be used in method 1700 to identify ranking and recall limitations of previously displayed profiles and to devise reformulation schemes for query intent clusters. For example, starting with a set of desired candidates for a title (i.e., desired hires for a given job title) specified by the stream, an embodiment represents a candidate profile as a bag of urns. In this example, an urn is an entity type associated with a member profile, where an entity type represents an attribute or feature of the member's profile (e.g., skills, education, experience, current and past organizations). For instance, member profiles can be uniquely identified by urns, where the urns can include urns for skills (e.g., C++ programming experience) and other urns for company or organization names (e.g., names of current and former employers). Implicit feedback received at operation 1708 can include measured metrics such as dwell time, profile sections viewed, and a number of revisits to a saved candidate profile.

At operation 1710, candidates are re-ranked and evaluated based on the measured feedback received at operation 1708. Correlations between explicit and implicit feedback received at operation 1708 can be used in operation 1710 to determine relative weights of member urns in a profile in order to quickly converge on a set of candidates in a streaming environment.

The re-ranking and evaluation of operation 1710 can include performing a cold start of a ranking model with a first candidate and user feedback that the first candidate received. In operation 1710, the ranking model can be used to rank a pool of candidates (excluding the first candidate since it has already been used). Based on the current ranking of the candidates determined in operation 1706, the method 1700 retrieves the candidate with the highest rating. This can be done in the context of an online system that is presenting a candidate to the user based on the feedback it has received thus far at operation 1708. Using the feedback for the current candidate received at operation 1708, and a feature vector representing the candidate to the ranking model, the method 1700 updates the ranking model by performing operation 1710.

In an embodiment, operation 1710 re-ranks the pool of candidates that have not yet been used according to the updated model. Then, the method 1700 repeatedly retrieves the candidate with the highest rating until all candidates in the pool have been exhausted.

To judge the effectiveness of the ranking model at selecting favorably rated candidates before unfavorably rated candidates, the method 1700 can include computing ranking metrics measuring precision and candidate feature weights as part of operation 1710.

The method 1700 can include implementing a simulated data flow for ingesting an initial ranking model at operation 1706 and updating it at operation 1710 based on feedback received and measured at operation 1708, and then performing further iterations of the offline experimental simulations by repeating operations 1708 and 1710. These offline experimental simulations can employ different models, use a warm-start of models, and utilize different features.

Due to limitations on the number of candidates per job in some recruiter tool log data or review data, there is a possibility that the method 1700 may not be able to produce meaningful results utilizing only such log or review data. In such cases, an embodiment supplements log or review data with impression data from the recruiter tool. This embodiment can implement reinforcement learning using desired hires or ideal candidates, both in the context of automated sourcing.

Some embodiments use explicit and implicit feedbacks that are given by recruiter users, rather than other users such as hiring managers. These embodiments can potentially take less domain knowledge into account by not relying on feedback from an organization's hiring manager.

Certain embodiments incorporate feedback received at operation 1708 to update candidate rankings offline at operation 1710.

As shown, operations 1708 and 1710 can be repeated to perform re-ranking and evaluation based on repeated user feedback received at operation 1708.

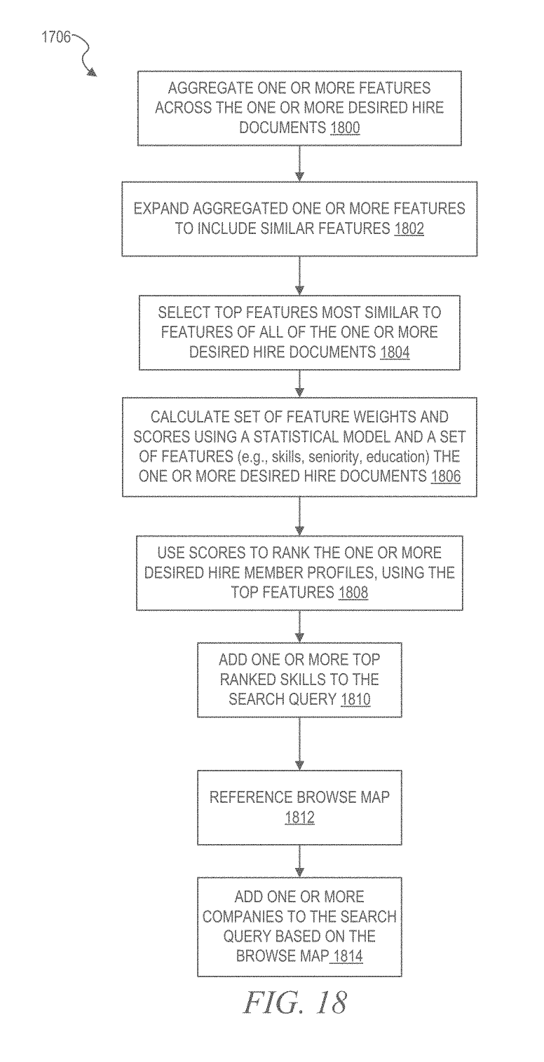

FIG. 18 is a flow diagram illustrating generating a search query based on extracted one or more features, in accordance with an example embodiment. FIG. 18 corresponds to operations 1706 and 1710 of FIG. 17 in more detail. At operation 1800, the one or more features are aggregated across the one or more desired hire documents. At operation 1802, the aggregated one or more features are expanded to include similar features. At operation 1804, top features most similar to features of the entire one or more desired hire documents are selected. At operation 1806, a set of feature weights and scores are calculated using a statistical model and a set of features regarding skills of the one or more candidate documents. The statistical model may be a logistic regression model trained using a machine learning algorithm. At operation 1808, the weights and scores are used to rank candidates of the one or more desired hire member profiles, using the top features (e.g., expertise scores based on ranked skills, and/or other scores based on seniority, education, or other parameters). At operation 1810, one or more top ranked candidates are determined.

At operation 1812, a browse map is referenced to determine user feedback, both explicit and implicit, regarding presented candidates. At operation 1814, one or more organizations are added to the search query, with the organizations being ones who have been co-viewed during the same browsing session as an organization identified in one or more of the desired hire documents, by using the browse map.

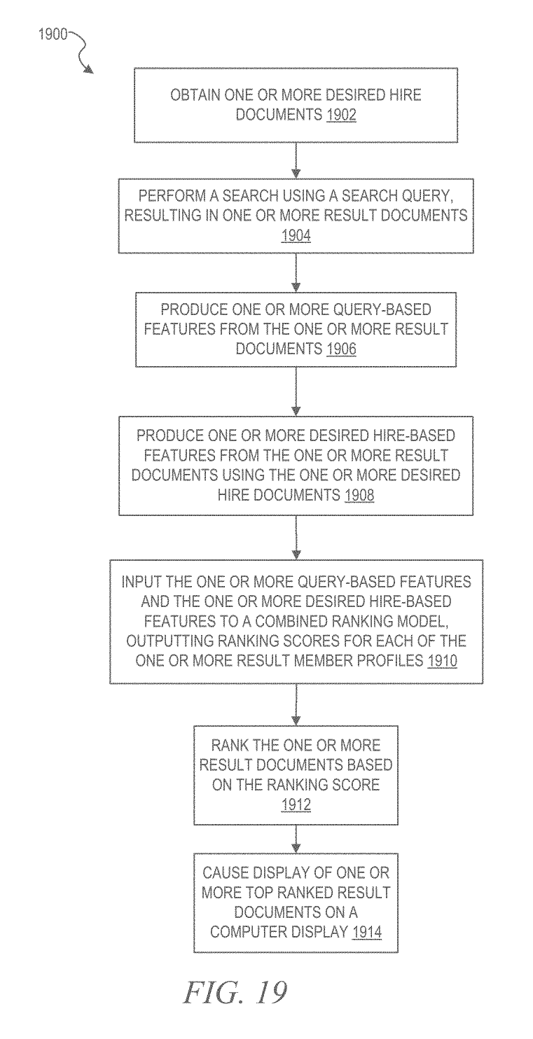

FIG. 19 is a How diagram illustrating a method 1900 of ranking search results using desired hires, in accordance with an example embodiment. At operation 1902, one or more desired hire documents may be obtained. In an example embodiment, these documents are member profiles in a social networking service and they are obtained by a searcher specifying the corresponding members and the member profiles being retrieved from a database based on the searcher's specified members. However, implementations are possible where the documents obtained are not member profiles.

At operation 1904, a search is performed using a search query, resulting in one or more result documents. Like with the desired hire documents, the result documents may be member profiles in an example embodiment. In one example embodiment, operation 1904 can be performed using some of the operations described above with respect to FIGS. 17 and 18.

At operation 1906, one or more query-based features are produced from the one or more result documents using the search query. As described above, this may include features such as TF-IDF.

At operation 1908, one or more desired hire-based features may be produced from the one or more result documents using the one or more desired hire documents. As described above, the desired hire-based features may include skill similarity, headline matching, headline similarity, and/or browsemap similarity.

At operation 1910, the one or more query-based features and the one or more desired hire-based features are input to a combined ranking model, outputting ranking scores for each of the one or more result member profiles. The combined ranking model may be trained using similar query-based and desired hire-based features from sample result documents as well as sample search queries and labels.

At operation 1912, the one or more result documents are ranked based on the ranking score. At operation 1914, display of the one or more top ranked result documents on a computer display is caused.

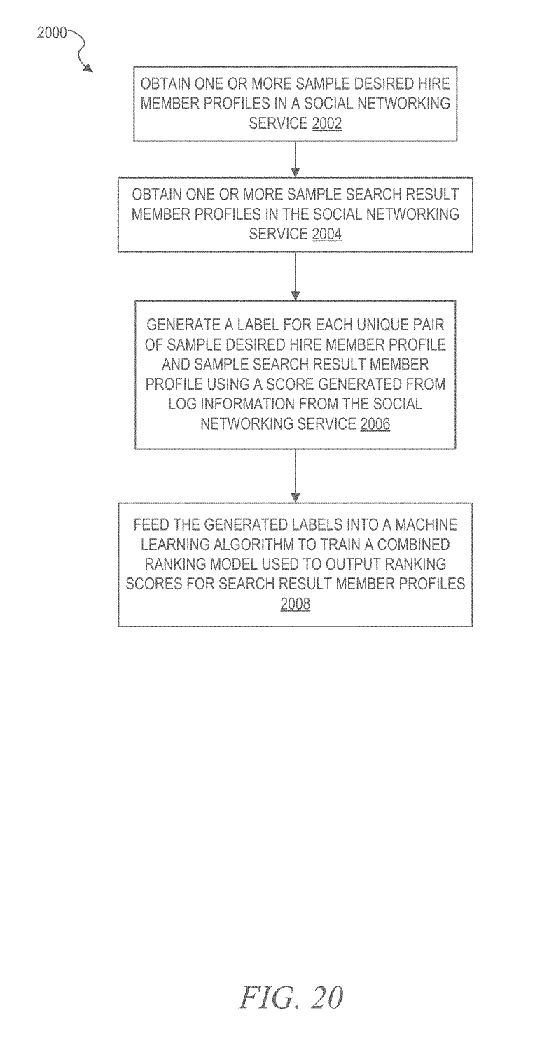

FIG. 20 is a flow diagram illustrating a method 2000 for generating labels for sample desired hire member profiles, in accordance with an example embodiment. At operation 2002, one or more sample desired hire member profiles in a social networking service are obtained. At operation. 2004, one or more sample search result member profiles in the social networking service are obtained. At operation 2006, for each unique pair of sample desired hire member profile and sample search result member profile, a label is generated using a score generated from log information of the social networking service. The log information includes records of communications between a searcher and members of the social networking service, the score being higher if the searcher communicated with both the member corresponding to the sample desired hire member profile and the member corresponding to the sample search result member profile in a same search session. The log information may further include records of user input by the searcher, with the user input causing interaction with member profiles in the social networking service but not resulting in communications between the searcher and the member of the social networking service corresponding to both the sample desired hire member profile and the sample search result member profile in the same search session. An example would include clicking on member profiles and viewing the member profiles but not emailing the corresponding members. A search session may be defined in a number of different ways. In one example embodiment, a search session is the same as a browsing session (e.g., as long as the searcher is logged in to the social networking service). In another example embodiment the search session is limited to a period of time between a searcher initiating a search and the searcher submitting an unrelated search or logging off the social networking service.

At operation 2008, the generated labels are fed into a machine learning algorithm to train a combined ranking model used to output ranking scores for search result member profiles.

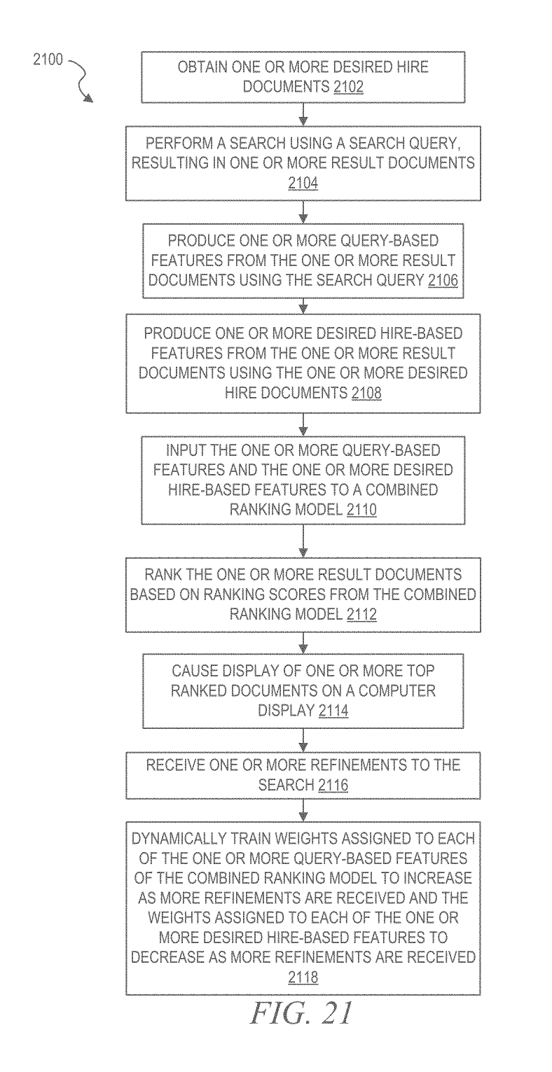

FIG. 21 is a flow diagram illustrating a method 2100 of dynamically training weights of a machine learning algorithm model, in accordance with an example embodiment. At operation 2102, one or more desired hire documents are obtained. At operation 2104, a search is performed using a search query, returning one or more result documents. This search query may or may not have been generated using the one or more desired hire documents.

At operation 2106, one or more query-based features are produced from the one or more result documents using the search query. At operation 2108, one or more desired hire-based features are produced from the one or more result documents using the one or more desired hire documents. At operation 2110, the one or more query-based features and the one or more desired hire-based features are input to a combined ranking model. The combined ranking model is trained by a machine learning algorithm to output a ranking score for each of the one or more result documents. The combined ranking model includes weights assigned to each of the one or more query-based features and each of the one or more desired hire-based features.

At operation 2112, the one or more result documents are ranked based on the ranking scores. At operation 2114, display of one or more top ranked documents on a computer display is caused. At operation 2116, one or more refinements to the search are received. The refinements can include explicit and implicit user feedback. At operation 2118, the weights assigned to each of the one or more query-based features are dynamically trained to increase as more refinements are received, and the weights assigned to each of the one or more desired hire-based features are dynamically trained to be altered (e.g., increased or decreased) as more refinements are received. This dynamic training may utilize a decay function based on, for example, time or number of refinements.

FIG. 22 is a screen capture illustrating a first screen 2200 of a user interface for performing a desired hire-based search, in accordance with an example embodiment. The first screen 2200 includes an area 2202 where a searcher can specify one or more desired hires for the search.

FIG. 23 is a screen capture illustrating a second screen 2300 of the user interface for performing a desired hire-based search, in accordance with an example embodiment. The second screen 2300 presents results 2302 of the search, as well as displaying the query generated using the specified desired hires (i.e., the query used for the search). The query may be displayed by highlighting terms of the query in various categories. For example, ‘software engineer’ 2304 is a job title that was generated for the query, ‘python’ 2306 is a skill that was generated for the query, and ‘Internet’ 2308 is an industry that was generated for the query. The searcher can then easily modify the query by adding additional terms to the query and/or removing some of the identified terms that had been previously generated.

### Blocks, Components, and Logic

Certain embodiments are described herein as including logic or a number of components, blocks, modules, or mechanisms. Blocks may constitute machine components implemented as a combination of software modules (e.g., code embodied on a machine-readable medium) and hardware modules. A ‘hardware module’ is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, as used herein, according to certain embodiments, the term ‘hardware module’ should be understood to encompass a tangible entity, be that an entity that is physically constructed, permanently configured (e.g., hardwired), or temporarily configured (e.g., programmed) to operate in a certain manner or to perform certain operations described herein. As used herein, ‘hardware-implemented module’ refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide Information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, ‘processor-implemented module’ refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a ‘cloud computing’ environment or as a ‘software as a service’ (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but also deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications, and so forth described in conjunction with FIGS. 1-23 are implemented in some embodiments in the context of a machine and an associated software architecture. The sections below describe representative software architecture(s) and machine (e.g., hardware) architecture(s) that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the ‘internet of things,’ while yet another combination produces a server computer for use within a cloud computing architecture. Not all combinations of such software and hardware architectures are presented here, as those of skill in the art can readily understand how to implement the inventive subject matter in different contexts from the disclosure contained herein.

### Software Architecture

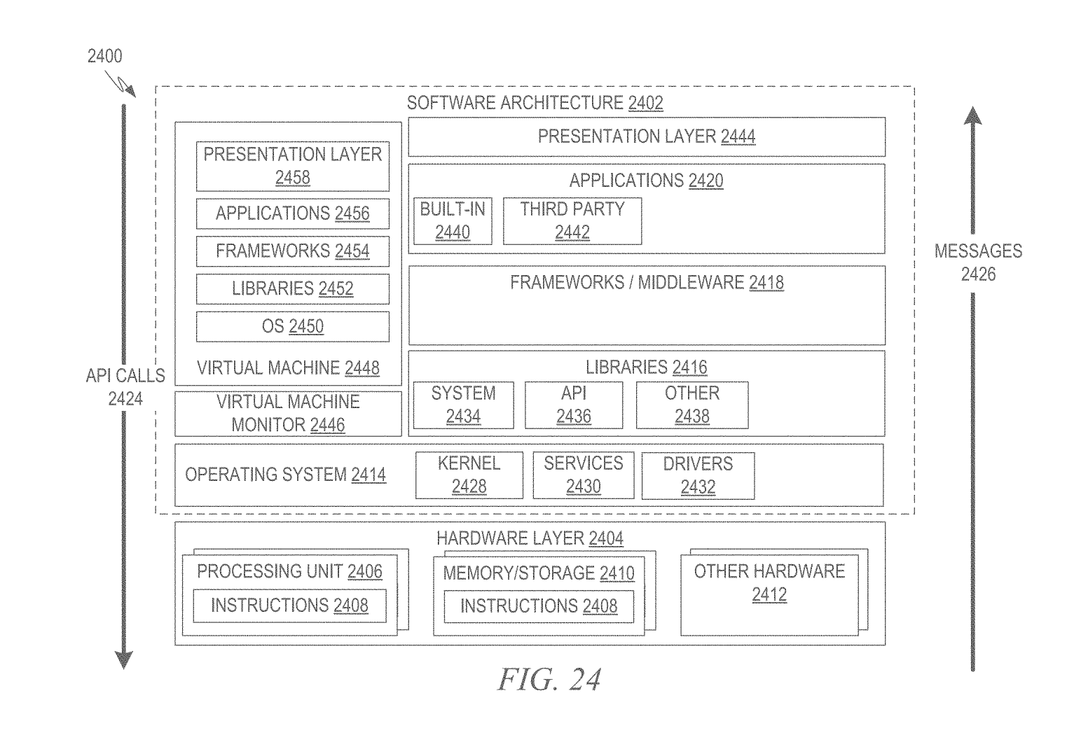

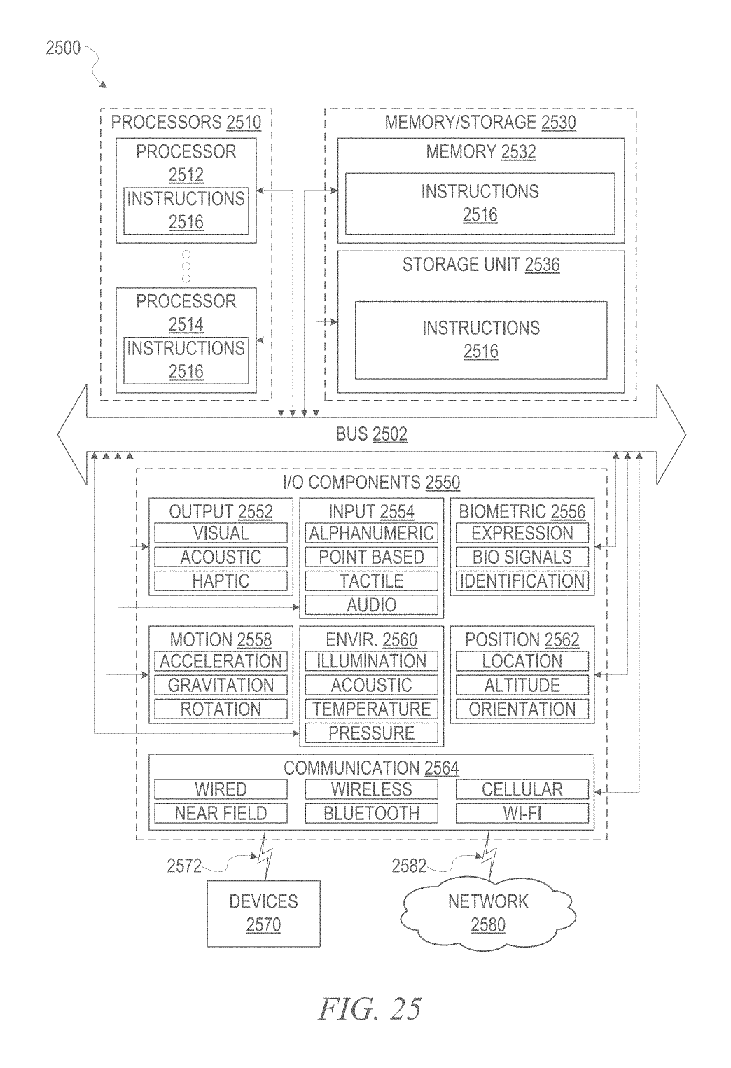

FIG. 24 is a block diagram 2400 illustrating a representative software architecture 2402, which may be used in conjunction with various hardware architectures herein described. FIG. 24 is merely a non-limiting example of a software architecture, and it will be appreciated that many other architectures may be implemented to facilitate the functionality described herein. The software architecture 2402 may be executing on hardware such as a machine 2500 of FIG. 25 that includes, among other things, processors 2510, memory/storage 2530, and I/O components 2550. A representative hardware layer 2404 is illustrated and can represent, for example, the machine 2500 of FIG. 25. The representative hardware layer 2404 comprises one or more processing units 2406 having associated executable instructions 2408. The executable instructions 2408 represent the executable instructions of the software architecture 2402, including implementation of the methods, modules, and so forth of FIGS. 1-23. The hardware layer 2404 also includes memory and/or storage modules 2410, which also have the executable instructions 2408. The hardware layer 2404 may also comprise other hardware 2412, which represents any other hardware of the hardware layer 2404, such as the other hardware illustrated as part of the machine 2500.

In the example architecture of FIG. 24, the software architecture 2402 may be conceptualized as a stack of layers where each layer provides particular functionality. For example, the software architecture 2402 may include layers such as an operating system 2414, libraries 2416, frameworks/middleware 2418, applications 2420, and a presentation layer 2444. Operationally, the applications 2420 and/or other components within the layers may invoke API calls 2424 through the software stack and receive responses, returned values, and so forth, illustrated as messages 2426, in response to the API calls 2424. The layers illustrated are representative in nature and not all software architectures have all layers. For example, some mobile or special purpose operating systems may not provide a layer of frameworks/middleware 2418, while others may provide such a layer. Other software architectures may include additional or different layers.

The operating system 2414 may manage hardware resources and provide common services. The operating system 2414 may include, for example, a kernel 2428, services 2430, and drivers 2432. The kernel 2428 may act as an abstraction layer between the hardware and the other software layers. For example, the kernel 2428 may be responsible for memory management, processor management (e.g., scheduling), component management, networking, security settings, and so on. The services 2430 may provide other common services for the other software layers. The drivers 2432 may be responsible for controlling or interfacing with the underlying hardware. For Instance, the drivers 2432 may include display drivers, camera drivers, Bluetooth® drivers, Hash memory drivers, serial communication drivers (e.g., Universal Serial Bus (USB) drivers), Wi-Fi® drivers, audio drivers, power management drivers, and so forth depending on the hardware configuration.

The libraries 2416 may provide a common infrastructure that may be utilized by the applications 2420 and/or other components and/or layers. The libraries 2416 typically provide functionality that allows other software modules to perform tasks in an easier fashion than by interfacing directly with the underlying operating system 2414 functionality (e.g., kernel 2428, services 2430, and/or drivers 2432). The libraries 2416 may include system libraries 2434 (e.g., C standard library) that may provide functions such as memory allocation functions, string manipulation functions, mathematic functions, and the like. In addition, the libraries 2416 may include API libraries 2436 such as media libraries (e.g., libraries to support presentation and manipulation of various media formats such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 2416 may also include a wide variety of other libraries 2438 to provide many other APIs to the applications 2420 and other software components/modules.

The frameworks 2418 (also sometimes referred to as middleware) may provide a higher-level common infrastructure that may be utilized by the applications 2420 and/or other software components/modules. For example, the frameworks 2418 may provide various graphic user interface (GUI) functions, high-level resource management, high-level location services, and so forth. The frameworks 2418 may provide a broad spectrum of other APIs that may be utilized by the applications 2420 and/or other software components/modules, some of which may be specific to a particular operating system or platform.

The applications 2420 include built-in applications 2440 and/or third party applications 2442. Examples of representative built-in applications 2440 may include, but are not limited to, a contacts application, a browser application, a book reader application, a location application, a media application, a messaging application, and/or a game application. The third party applications 2442 may include any of the built-in applications 2440 as well as a broad assortment of other applications. In a specific example, the third party application 2442 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 2442 may invoke the API calls 2424 provided by the mobile operating system such as the operating system 2414 to facilitate functionality described herein.

The applications 2420 may utilize built-in operating system 2414 functions (e.g., kernel 2428, services 2430, and/or drivers 2432), libraries 2416 (e.g., system libraries 2434, API libraries 2436, and other libraries 2438), and frameworks/middleware 2418 to create user interfaces to interact with users of the system. Alternatively, or additionally, in some systems, interactions with a user may occur through a presentation, layer, such as the presentation layer 2444. In these systems, the application/module ‘logic’ can be separated from the aspects of the application/module that interact with a user.

Some software architectures utilize virtual machines. In the example of FIG. 24, this is illustrated by a virtual machine 2448. A virtual machine creates a software environment where applications/modules can execute as if they were executing on a hardware machine (such as the machine 2500 of FIG. 25, for example). A virtual machine is hosted by a host operating system (e.g., operating system 2414 in FIG. 24) and typically, although not always, has a virtual machine monitor 2446, which manages the operation of the virtual machine 2448 as well as the interface with the host operating system (e.g., operating system 2414). A software architecture executes within the virtual machine 2448, such as an operating system 2450, libraries 2452, frameworks/middleware 2454, applications 2456, and/or a presentation layer 2458. These layers of software architecture executing within the virtual machine 2448 can be the same as corresponding layers previously described or may be different.

### Example Machine Architecture and Machine-Readable Medium

FIG. 25 is a block diagram illustrating components of a machine 2500, according to some example embodiments, able to read instructions from a machine-readable medium (e.g., a machine-readable storage medium) and perform any one or more of the methodologies discussed herein. Specifically, FIG. 25 shows a diagrammatic representation of the machine 2500 in the example form of a computer system, within which instructions 2516 (e.g., software, a program, an application, an applet, an app, or other executable code) for causing the machine 2500 to perform any-one or more of the methodologies discussed herein may be executed. The instructions 2516 transform the general, non-programmed machine into a particular machine programmed to carry out the described and illustrated functions in the manner described. In alternative embodiments, the machine 2500 operates as a standalone device or may be coupled (e.g., networked) to other machines. In a networked deployment, the machine 2500 may operate in the capacity of a server machine or a client machine in a server-client network environment, or as a peer machine in a peer-to-peer (or distributed) network environment. The machine 2500 may comprise, but not be limited to, a server computer, a client computer, a PC, a tablet computer, a laptop computer, a netbook, a set-top box (STB), a personal digital assistant. (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 2516, sequentially or otherwise, that specify actions to be taken by the machine 2500. Further, while only a single machine 2500 is illustrated, the terra ‘machine’ shall also be taken to include a collection of machines 2500 that individually or jointly execute the instructions 2516 to perform any one or more of the methodologies discussed herein.

The machine 2500 may include processors 2510, memory/storage 2530, and I/O components 2550, which may be configured to communicate with each other such as via a bus 2502. In an example embodiment, the processors 2510 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 2512 and a processor 2514 that may execute the instructions 2516. The term ‘processor’ is intended to include multi-core processors that may comprise two or more independent processors (sometimes referred to as ‘cores’) that may execute instructions contemporaneously. Although FIG. 25 shows multiple processors 2510, the machine 2500 may include a single processor with a single core, a single processor with multiple cores (e.g., a multi-core processor), multiple processors with a single core, multiple processors with multiples cores, or any combination thereof.

The memory/storage 2530 may include a memory 2532, such as a main memory, or other memory storage, and a storage unit 2536, both accessible to the processors 2510 such as via the bus 2502. The storage unit 2536 and memory 2532 store the instructions 2516 embodying any one or more of the methodologies or functions described herein. The instructions 2516 may also reside, completely or partially, within the memory 2532, within the storage unit 2536, within at least one of the processors 2510 (e.g., within the processor's cache memory), any suitable combination thereof, during execution thereof by the machine 2500. Accordingly, the memory 2532, the storage unit 2536, and the memory of the processors 2510 are examples of machine-readable media.

As used herein, ‘machine-readable medium’ means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term ‘machine-readable medium’ should be taken to include a single medium or multiple media (e.g., a centralized or distributed database, or associated caches and servers) able to store the instructions 2516. The term ‘machine-readable medium’ shall also be taken to include any medium, or combination of multiple media, that is capable of storing instructions (e.g., instructions 2516) for execution by a machine (e.g., machine 2500), such that the instructions, when executed by one or more processors of the machine (e.g., processors 2510), cause the machine to perform any one or more of the methodologies described herein. Accordingly, a ‘machine-readable medium’ refers to a single storage apparatus or device, as well as ‘cloud-based’ storage systems or storage networks that include multiple storage apparatus or devices. The term ‘machine-readable medium’ excludes signals per se.

The I/O components 2550 may include a wide variety of components to receive input, provide output, produce output, transmit information, exchange information, capture measurements, and so on. The specific I/O components 2550 that are included in a particular machine will depend on the type of machine. For example, portable machines such as mobile phones will likely include a touch input device or other such input mechanisms, while a headless server machine will likely not include such a touch input device. It will be appreciated that the I/O components 2550 may include many other components that are not shown in FIG. 25. The I/O components 2550 are grouped according to functionality merely for simplifying the following discussion and the grouping is in no way limiting. In various example embodiments, the I/O components 2550 may include output components 2552 and input components 2554. The output components 2552 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 2554 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 2550 may Include biometric components 2556, motion components 2558, environmental components 2560, or position components 2562, among a wide array of other components. For example, the biometric components 2556 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 2558 may include acceleration sensor components (e.g., accelerometer), gravitation sensor components, rotation sensor components (e.g., gyroscope), and so forth. The environmental components 2560 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 2562 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 2550 may include communication components 2564 operable to couple the machine 2500 to a network 2580 or devices 2570 via a coupling 2582 and a coupling 2572, respectively. For example, the communication components 2564 may include a network interface component or other suitable device to interface with the network 2580. In further examples, the communication components 2564 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 2570 may be another machine or any of a wide variety of peripheral devices (e.g., a peripheral device coupled via a USB).

Moreover, the communication components 2564 may detect identifiers or include components operable to detect identifiers. For example, the communication components 2564 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 2564, such as location via Internet Protocol (IP) geolocation, location via Wi-Fi® signal triangulation, location via detecting an NFC beacon signal that may indicate a particular location, and so forth.

### Transmission Medium

In various example embodiments, one or more portions of the network 2580 may be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 2580 or a portion of the network 2580 may include a wireless or cellular network and the coupling 2582 may be a Code Division Multiple Access (CDMA) connection, a Global System for Mobile communications (GSM) connection, or another type of cellular or wireless coupling. In this example. the coupling 2582 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 2516 may be transmitted or received over the network 2580 using a transmission medium via a network interface device (e.g., a network interface component included in the communication components 2564) and utilizing any one of a number of well-known transfer protocols (e.g., HTTP). Similarly, the instructions 2516 may be transmitted or received using a transmission medium via the coupling 2572 (e.g., a peer-to-peer coupling) to the devices 2570. The term ‘transmission medium’ shall be taken to include any intangible medium that is capable of storing, encoding, or carrying the instructions 2516 for execution by the machine 2500, and includes digital or analog communications signals or other intangible media to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term ‘Invention’ merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term ‘or’ may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific Illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer system, comprising:
one or more processors; and
a non-transitory computer readable storage medium storing instructions that when executed by the one or more processors cause the computer system to perform operations comprising:
obtaining one or more desired hire documents using a search query specifying one or more parameters;
extracting one or more desired hire-based features from the one or more desired hire documents, the one or more desired hire-based features corresponding to the one or more parameters;
inputting the one or more desired hire-based features to a combined ranking model, the combined ranking model trained by a machine learning algorithm to output a ranking score for each of the one or more desired hire documents, the combined ranking model including weights assigned to each of the one or more desired hire-based features;
ranking the one or more desired hire documents based on the ranking scores;
causing the one or more top ranked documents to be displayed on a display device;
receiving feedback regarding the displayed one or more top ranked documents; and
dynamically training the weights assigned to each of the one or more desired hire-based features to alter the weights assigned to each of the one or more desired hire-based features based on the received feedback.

2. The system of claim 1, wherein the desired hire documents are member profiles in a social networking service.

3. The system of claim 1, wherein the instructions further cause the system to:
repeating the ranking based on the altered weights;
updating the display of the one or more top ranked documents on the display device, the updating being based on the repeating;
receiving additional feedback regarding the updated display of the one or more top ranked documents; and
dynamically re-training the weights assigned to each of the one or more desired hire-based features to alter the weights assigned to each of the one or more desired hire-based features based on the additional feedback.

4. The system of claim 1, wherein the feedback includes explicit feedback received from a user interacting with the display of the one or more top ranked documents.

5. The system of claim 4, wherein the explicit feedback includes one of: acceptance, deferral, or rejection of a candidate corresponding to one of the displayed one or more top ranked documents.

6. The system of claim 1, wherein the feedback includes implicit feedback received from a user interacting with the display of the one or more top ranked documents.

7. The system of claim 6, wherein the implicit feedback includes measured metrics corresponding to one or more of dwell time on the displayed one or more top ranked documents, profile sections viewed of the displayed one or more top ranked documents, and a number of revisits to the displayed one or more top ranked documents.

8. A computer-implemented method, comprising:
obtaining one or more desired hire documents using a search query specifying one or more parameters;
extracting one or more desired hire-based features from the one or more desired hire documents, the one or more features corresponding to the one or more parameters;
inputting the one or more desired hire-based features to a combined ranking model, the combined ranking model trained by a machine learning algorithm to output a ranking score for each of the one or more desired hire documents, the combined ranking model including weights assigned to each of the one or more desired hire-based features;
ranking the one or more desired hire documents based on the ranking scores;
causing display of one or more top ranked documents on a display device;
receiving feedback regarding the displayed one or more top ranked documents; and
dynamically training the weights assigned to each of the one or more desired hire-based features to alter the weights assigned to each of the one or more desired hire-based features based on the received feedback.

9. The method of claim 8, wherein the desired hire documents are member profiles in a social networking service.

10. The method of claim 8, further comprising:
repeating the ranking based on the altered weights;
updating the display of the one or more top ranked documents on the display device, the updating being based on the repeating;
receiving additional feedback regarding the updated display of the one or more top ranked documents; and
dynamically re-training the weights assigned to each of the one or more desired hire-based features to alter the weights assigned to each of the one or more desired hire-based features based on the additional feedback.

11. The method of claim 8, wherein the feedback includes explicit feedback received from a user interacting with the display of the one or more top ranked documents.

12. The method of claim 11, wherein the explicit feedback includes one of: acceptance, deferral, or rejection of a candidate corresponding to one of the displayed one or more top ranked documents.

13. The method of claim 8, wherein the feedback includes implicit feedback received from a user interacting with the display of the one or more top ranked documents.

14. The method of claim 13, wherein the implicit feedback includes measured metrics corresponding to one or more of dwell time on the displayed one or more top ranked documents, profile sections viewed of the displayed one or more top ranked documents, and a number of revisits to the displayed one or more top ranked documents.

15. A non-transitory machine-readable storage medium comprising instructions, which when implemented by one or more machines, cause the one or more machines to perform operations comprising:
obtaining one or more desired hire documents using a search query specifying one or more parameters;
extracting one or more desired hire-based features from the one or more desired hire documents, the one or more features corresponding to the one or more parameters;
inputting the one or more desired hire-based features to a combined ranking model, the combined ranking model trained by a machine learning algorithm to output a ranking score for each of the one or more desired hire documents, the combined ranking model including weights assigned to each of the one or more desired hire-based features;
ranking the one or more desired hire documents based on the ranking scores;
causing display of one or more top ranked documents on a display device;
receiving feedback regarding the displayed one or more top ranked documents; and
dynamically training the weights assigned to each of the one or more desired hire-based features to alter the weights assigned to each of the one or more desired hire-based features based on the received feedback.

16. The non-transitory machine-readable storage medium of claim 15, wherein the desired hire documents are member profiles in a social networking service.

17. The non-transitory machine-readable storage medium of claim 15, wherein the operations further comprise:
repeating the ranking based on the altered weights;
updating the display of the one or more top ranked documents on the display device, the updating being based on the repeating;
receiving additional feedback regarding the updated display of the one or more top ranked documents; and
dynamically re-training the weights assigned to each of the one or more desired hire-based features to alter the weights assigned to each of the one or more desired hire-based features based on the additional feedback.

18. The non-transitory machine-readable storage medium of claim 15, wherein the feedback includes explicit feedback received from a user interacting with the display of the one or more top ranked documents.

19. The non-transitory machine-readable storage medium of claim 18, wherein the explicit feedback includes one of: acceptance, deferral, or rejection of a candidate corresponding to one of the displayed one or more top ranked documents.

20. The non-transitory machine-readable storage medium of claim 15, wherein the feedback includes implicit feedback received from a user interacting with the display of the one or more top ranked documents, and wherein the implicit feedback includes measured metrics corresponding to one or more of dwell time on the displayed one or more top ranked documents, profile sections viewed of the displayed one or more top ranked documents, and a number of revisits to the displayed one or more top ranked documents.
